(19) United States
(12) Patent Application Publication
(10) Pub. No.: US 2011/0011925 A1
(43) Pub. Date: Jan. 20, 2011

(54) REMOTE CONTROL DEVICE POSSIBLE TO READ OUT DOT PATTERN FORMED ON MEDIUM OR DISPLAY

(76) Inventor: Kenji Yoshida, Tokyo (JP)

Correspondence Address: Konomi Takeshita, Eight Penn Center, Suite 1300,, 1628 John F. Kennedy Blvd., Philadelphia, PA, 19103, US

(21) Appl. No.: 12/809,678

(22) PCT Filed: Dec. 22, 2008
(86) PCT No.: PCT/JP2008/003881

§ 371 Date: Sep. 20, 2010

(30) Foreign Application Priority Data
Dec. 21, 2007 (JP) 2007-331020

(51) Int. Cl. G05B 19/02; G06K 7/14

(52) U.S. Cl. 235/375

(57) ABSTRACT

A remote control device that can be intuitively operated, that does not require users to take time to learn operation and that is excellent in convenience, operability and affinity for users is provided. The remote control device includes an optical reading unit equipped on a predetermined medium surface, for reading a dot pattern, a main body that is provided in connection with the optical reading unit and can be held like a pen or gripping-held, a conversion unit for converting the dot pattern read by the optical reading unit into one or more corresponding transmission codes, an operation unit equipped on the surface of the main body in the vicinity of the optical reading unit and operable with a fingertip, for moving a cursor, selecting a menu, selecting a program and determining the selections, and a transmission unit for transmitting the transmission code converted by the conversion unit and an operational instruction provided by the operation unit as signals to a controlled apparatus.

### CROSS REFERENCE TO RELATED APPLICATIONS

This application claims priority under 35 U.S.C. 119 based upon Japanese Patent Application Serial No. 2007-331020, filed on Dec. 21, 2007. The entire disclosures of the aforesaid applications are incorporated herein by reference.

### FIELD OF THE INVENTION

The present invention relates to a remote control device which is capable of reading a dot pattern formed on a medium and a display and used for remotely operating home electric appliances, electric devices, and the like.

### BACKGROUND OF THE INVENTION

Recently, home electric appliances, electric devices, and the like, have been significantly progressed, with new products developed and sold day after day. For example, in a television field, products (a television and a set-top box) that can receive a variety of television broadcasts, including satellite broadcast and cable television as well as conventional terrestrial broadcast, are increasing. In addition, the set-top boxes that can be connected to a television and display/output a variety of content on the television, are increasingly available including a possibility of browsing of the Internet, mail-ordering, and doing karaoke.

As the home electric appliances, such as a television, offering an increasing range of functions and even more sophisticated functionalities as described above, remote control devices for carrying out operations and controls of the appliances (hereafter, referred to as the “remote control device”) tend to have more operation buttons and become larger in sizes, while the operation procedures become complicated.

However, a large remote control device has a problem in which it is hard to hold the device and the device gives low affinity for users. Further, due to a large number of its operation buttons and complicated operation procedures, it is hard for users to understand which button to press to get a desired operation and takes time to become familiar with operations of the remote control device.

To solve such problems, there is proposed a remote control device such as the one in Patent Literature 1. The remote control device disclosed in Patent Literature 1 has a shape in which three generally flat plates are connected with each other and the cross-section shape in the connected direction forms a generally arched shape. Having such a shape allows a user to perform operations in an effortless position when the user operates with one hand. Also, operation units for instructing operations according to a first objective (control of an information processing application) are disposed on surfaces on the top sides of the flat plates disposed at both ends of the remote control device, and an operation unit for instructing operations according to a second objective (control of normal television broadcast and data broadcast) is disposed on a surface on the bottom side of the middle flat plate. Due to such a structure, the holding form of the remote control device is different between the first and the second objectives, which allows a user to operate multifunctional controlled apparatus with easier operation than the conventional way.

However, in Patent Literature 1, there is a problem in which, although it is easy to understand which side should be used to operate user's target control, it requires considerable time to learn and understand which operation button should be pressed when performing an actual operation, due to a large number of operation buttons and wheels disposed on both sides of the remote control device.

Further, if a conventional remote control device including the one in Patent Literature 1 is used to control an apparatus compatible with cable television, multi-channel satellite broadcast, and terrestrial digital broadcast, a menu is first required to be shown on a television screen, and from that menu, a user should reach a target operation instruction screen while following a hierarchical structure. This requires the user to perform complicated operational procedures to get the desired operation done.

The present invention has been devised in consideration of the above points and aims to achieve a technical subject that is to provide a remote control device with excellent convenience, operability and affinity, which allows intuitive operation and requires less time for learning operations.

### SUMMARY OF THE INVENTION

(1) A remote control device according to the present invention is a remote control device for operating a set-top box, a mobile phone, a game console or the like connected to a television or a display device as a controlled apparatus, comprising: an optical reading unit equipped on a predetermined medium surface, for reading an optically readable dot pattern made in a pattern based on a predetermined algorithm; a main body that is provided in connection with the optical reading unit and can be held like a pen or gripping-held according to a user and/or a purpose of use; a conversion unit equipped inside the main body, for analyzing a dot code and/or a coordinate value from the dot pattern read out by the optical reading unit and converting the dot code and/or the coordinate value into one or more corresponding transmission codes; an operation unit equipped on a surface of the main body in the vicinity of the optical reading unit and capable of being operated by a fingertip, for at least moving a cursor, selecting a menu, selecting a program and determining the selections being displayed on the television or the display device; and one or more transmission units equipped on the main body, for transmitting as signals the transmission code converted by the conversion unit and an operation instruction command provided by the operation unit to the controlled apparatus.

The term “holding like a pen” is used for a way of gripping the remote control device such that the operation unit is operated by an index finger while the main body is held by pulps of thumb and a middle finger, and the term “gripping-holding” is used for a way of gripping the same such that the operation unit is operated by a thumb while the main body is held by four fingers other than the thumb, or a way of gripping the same such that the operation unit is operated by an index finger while the main body is held by a thumb, a middle finger, a ring finger and a little finger. For example, the “holding like a pen” is the way of holding shown in FIGS. 17A and 17B, and the “gripping-holding” is the way of holding shown in FIGS. 17C and 17D. However, the way of gripping the remote control is not limited to these ways of gripping shown in these figures.

The present remote control device has a shape that allows it to be held like a pen or gripping-held according to user's preference or an intended use. The main body of the remote control is provided with the optical reading unit that can read an optically readable dot pattern (explained later in detail) that is provided on a medium surface of a booklet,for operations, a program guide, a program list or the like and is made into a pattern based on a predetermined algorithm.

The dot pattern read out by the optical reading unit is analyzed into a dot code and/or a coordinate value and converted into one or more transmission codes corresponding to the same, such as power on/off or recording, by the converter equipped inside the main body.

In addition, the operation unit equipped in the vicinity of the optical reading unit of the main body of the remote control can be operated with a fingertip, and can move a cursor, select a menu, select a program and determine the selections being displayed on the television or the display device.

Since the transmission code converted and the operation instruction command provided from the operation unit are transmitted as signals from the transmission unit to the controlled apparatus such as a set-top box, a mobile phone or a game console that is connected with the television or the display device, a user can control the controlled apparatus.

Therefore, an operation, playing content or the like can easily be performed through one-touch operation to the medium surface by the remote control device, and thus it is possible to provide a remote control device with excellent convenience, operability and affinity, which allows intuitive operation and requires less time for learning operations.

(2) A remote control device according to the present invention is a remote control device, in which the optical reading unit is provided at a bending distal end portion that is one end in the axial direction of the main body bent in an oblique direction, and the operation unit is provided in the vicinity of the origin of the bending of the main body, and the transmission unit is disposed at least in connection with the operation unit.

According to this, since one axial end of the main body is bent in the oblique direction and the optical reading unit is provided at the distal end thereof (bending distal end), when a user holds the remote control device like a pen to read a dot pattern from a medium, the optical reading unit at the distal end can read the dot pattern correctly.

In addition, since the operation unit is provided on a back face of the main body in the vicinity of the bending starting portion, the operation unit can be operated with a thumb, an index finger, a middle finger or the like while the remote control device is kept held like a pen, and thus a television set, a set-top box or the like can be operated without change in the way of holding the remote control device.

According to the above configuration, a remote control device with excellent operability can be provided.

(3) A remote control device according to the present invention is a remote control device, in which the optical reading unit can optically read the dot pattern that is printed on the medium surface or displayed on a display and made into a pattern based on the predetermined algorithm.

According to this, the present remote control device can easily read as a read target a dot pattern which is printed on a medium or displayed on a display and which is made into a pattern based on the predetermined algorithm.

(4) A remote control device according to the present invention is a remote control device, in which the optical reading unit can optically read the dot pattern that is printed on a transparent sheet which is an information input assisting sheet placed on the medium surface or attached on a display and made into a pattern based upon the predetermined algorithm.

According to this configuration, the present remote control device can optically read as a read target a dot pattern which is disposed on a medium or attached on a display, which is printed on a transparent sheet that is an information input assisting sheet, and which is made into a pattern based on a predetermined algorithm.

(5) A remote control device according to the present invention is a remote control device, in which the optical reading unit can optically read the dot pattern that is superimposed and printed on the medium or the information input assisting sheet with a still image such as a text, a figure, an illustration or a photograph; or the dot pattern that is superimposed and displayed on the display with a still image or a motion image.

According to this, it is possible to optically read the dot pattern which is superimposed and printed on the medium surface or the information input assisting sheet with a still image such as a text, a figure, an illustration or a photograph, or the dot pattern which is superimposed and displayed on a display with a still image or a motion image. By making such superimposing print and superimposing display possible, the need to separately prepare a region for displaying a dot pattern on a medium surface or the like is eliminated, so that a medium surface or the like with excellent appearance can be provided.

Further, since a user touches a text or an illustration through the remote control device and thereby simultaneously makes the remote control device read the dot pattern which has been printed or displayed in a superimposing manner with the text or the illustration, it is possible to operate the remote control device intuitively, and therefore it is possible to provide a remote control device with excellent convenience, operability and affinity.

(6) A remote control device according to the present invention is a remote control device, in which the operation unit has a transmission button with an operational function for outputting one or more signals from the transmission unit to the controlled apparatus, which is provided at a predetermined position.

According to this, a transmission code read out by the optical reading unit and converted by the conversion unit can arbitrarily be transmitted.

(7) A remote control device according to the present invention is a remote control unit, in which the transmission button has a repeat function for retransmitting one or more signals when the controlled apparatus fails to recognize a signal transmitted from the transmission unit and/or a batch transmission function a plurality of operations performed by reading the dot pattern by the optical reading unit.

According to this, when an infrared signal is transmitted and the transmission signal fails to be recognized by a controlled apparatus due to an obstacle or the like, a transmission code can easily be retransmitted. In addition, the remote control device can perform such a function as reading dot patterns continuously by the optical reading unit and collectively converting them into transmission codes so that one or more signals can collectively be transmitted, which provides a great convenience.

(8) A remote control device according to the present invention is a remote control device, in which the operation unit has a pointing device used as a coordinate indication input assisting device, such as a pointing stick that can move the cursor in an arbitrary direction by an arbitrary distance and select and determine a selection item arbitrarily.

(9) A remote control device according to the present invention is a remote control device, in which the operation unit is equipped with a plurality of operation buttons operable in at least vertical and horizontal directions, the buttons being independently disposed; or a single operation button operable in at least vertical and horizontal directions.

According to this, since the pointing device as a coordinate indication input assisting device, and/or arrow keys that can perform at least vertical and horizontal direction operations or a key having a function similar to the arrow keys are/is disposed in the operation unit of the remote control device, a user can easily select a menu and move a cursor, the menu and the cursor being displayed on a display, and thus it is made possible to provide a remote control device which is simple, very convenient and excellent in affinity to users.

(10) A remote control device according to the present invention is a remote control device, in which the operation unit is equipped with an enter button having a function for, after a predetermined operation is selected, determining the content of the selection in the middle of or the vicinity of the plurality of operation buttons operable in at least vertical and horizontal directions, or a pointing device that fulfills the same function as the enter button, when pressed.

(11) A remote control device according to the present invention is a remote control device, in which the operation unit is equipped with an enter button having a function for, after a predetermined operation is selected, determining the content of the selection in the middle of or the vicinity of the plurality of operation buttons operable in at least vertical and horizontal directions, or a single operation button operable in at least vertical and horizontal directions and fulfilling the same function as the enter button, when pressed at any one site.

According to this, since the selection of an item in a menu or the like is determined by the enter button or by pressing the pointing device or the operation buttons, the further effect of increasing convenience for users is achieved.

(12) A remote control device according to the present invention is a remote control device, in which the operation unit is equipped with at least one button having the same functions as those of the right and left buttons of a mouse to arbitrarily execute an operation corresponding to the position of the cursor displayed on a display.

According to this, since it is made possible by using the present remote control device to perform control of a personal computer and access to the Internet simultaneously, an interface device that is a new medium unitizing the Internet and television with each other can be realized. Incidentally, the button having the same function as right and left buttons of a mouse may be composed of two or more buttons or a single button having only the function of the left button or the right button of a mouse.

(13) A remote control device according to the present invention is a remote control device, in which the operation unit has a menu button having a function for displaying a list of contents and/or operation items provided by the controlled apparatus, and has a back button disposed in the vicinity of the menu button, for returning to the last menu display when selecting menu items sequentially.

According to this, since the menu display can be called up only by pressing one button, convenience for users is enhanced.

In addition, these menu button and back button may be provided with the functions of left and right buttons of a mouse, respectively. For example, the menu button may be provided with a function for calling up a main menu when the button is given a long press, and provided with a function for executing the function of the left button of a mouse when the button is given a short press.

The back button may be provided with a function for returning when the button is given a long press, and provided with the function of the right button of a mouse when the button is given a short press.

(14) A remote control device according to the present invention is a remote control device, in which the main body has a volume button for adjusting the volume of the controlled apparatus and a power button for turning on/off the controlled apparatus.

(15) A remote control device according to the present invention is a remote control device, in which one or more transmission units are provided in the vicinity of the operation unit and/or in the vicinity of a portion on the opposite side of the operation unit and transmit as infrared signals the transmission code converted by the conversion unit and an operation instruction command provided by the operation unit to the controlled apparatus.

According to this, since an infrared signal is transmitted to the controlled apparatus, a remote control device that is simply operated, very convenient and excellent in affinity to users can also be provided to a television receiver or a set-top box that has already been widespread.

(16) A remote control device according to the present invention is a remote control device, in which at least one of the transmission units is provided at a distal end portion on the opposite side of the operation unit.

(17) A remote control device according to the present invention is a remote control device, in which the transmission units are provided with infrared light emitting devices disposed at predetermined intervals in the circumference direction about the longitudinal axis of the main body.

According to this, the region of transmission of the infrared signal is expanded, and therefore a signal can be transmitted to the controlled apparatus regardless of the orientation of the main body of the remote control.

Further, when infrared transmission is perform in a state in which a user holds the main body of the remote control like a pen and reads a dot pattern on a medium, infrared transmission can be performed without being interfered with by a finger with which the remote control is operated, since the transmission unit is positioned at the uppermost portion of the remote control device, and therefore a remote control device that is highly convenient for users can be provided.

(18) A remote control device according to the present invention is a remote control device, in which the transmission units each comprise one or more infrared light emitting devices for emitting direct light to the side of the main body and a convex mirror portion or a diffuse reflection plate provided on the side of the main body, and a transmission region is expanded by reflecting direct light emitted from the infrared light emitting devices by the convex mirror portion or the diffuse reflection plate in many directions.

According to this, since the remote control device has a structure in which the convex mirror portion or the diffuse reflective plate that has a curved surface is disposed at a position that can expand an infrared-irradiated area, infrared emission can be performed such that the controlled apparatus can accurately be controlled even if the direction of infrared transmission of the remote control device is a little deviated from an infrared receiver of the controlled apparatus.

It is conventionally required to dispose LEDs in two places such that their infrared irradiation angles are about 60 degrees, however, one or a minimum number of LEDs is enough since it is made possible by providing the convex mirror portion or the diffuse reflective plate to further expand the infrared-irradiated area, and therefore it is made possible to reduce component cost and reduce consumed power significantly.

(19) A remote control device according to the present invention is a remote control device having a function that can perform vertical and horizontal direction operations, wherein in a state that a predetermined menu is displayed on a display and a plurality of items in the menu are selectable, one item can be selected and determined by recognizing a tilt of the longitudinal axis of the main body within a predetermined time period; an item positioned above or below the one item is selected by using the main body like a joystick and, from an initial tilt state of the main body, tilting the main body once at a predetermined angle or more in the opposite direction of an operator or tilting the main body once at a predetermined angle or more in the direction toward the operator, and an item positioned on the left or right side of the one item is selected by using the main body like a joystick and, from an initial tilt state of the main body, tilting the main body once at a predetermined angle or more to the left relative to the operator or tilting the main body once at a predetermined angle or more to the right relative to the operator, and, the remote control device is put into a standby state for a next operation if the main body is returned to the initial tilt state within a predetermined time period; and if the predetermined time period elapses, the items in vertical and horizontal directions are sequentially displayed and selected every time a predetermined time period elapses until the main body is returned to the initial tilt state.

According to this, since the remote control device is provided with a mechanism for detecting and recognizing the tilt of the main body, various operations can be performed by tilting actions or the like of the main body, and therefore a remote control device that is simply operated and has a great convenience and an excellent affinity for users can be provided.

(20) A remote control device according to the present invention is a remote control device having a function that can perform an arbitrary direction operation, wherein, in a state that a cursor is displayed on the display, and a predetermined item is selected and waiting to be determined or no item is selected, the main body is used like a joystick by recognizing temporal change in tilt of the longitudinal axis of the main body by a predetermined method; when the main body is tilted at a predetermined angle or more in an arbitrary direction from a tilting state of the main body, the cursor is moved according to a predetermined algorithm corresponding to an angle changed by tilting in the same direction, and an item becomes selected if the cursor is positioned over the item; and if the main body is returned to an initial tilting state, the cursor is stopped and the remote control device is put into a standby state for a next operation.

According to this, since the remote control device is provided with a mechanism for detecting and recognizing the tilt of the main body, various operations using the cursor can be performed by tilting actions of the main body, and therefore a remote control device that is simply operated has a great convenience and an excellent affinity for users can be provided.

(21) A remote control device according to the present invention is a remote control device having a function that can perform vertical and horizontal direction operations, wherein the main body is in an initial tilting state when the main body is approximately perpendicular to the medium surface with the optical reading unit touching the medium surface at the start time of recognizing a tilt; calibration setting is performed using the contrast state of an image read by the optical reading unit in the initial tilting state as an initial contrast state; and a change in angle when the main body is tilted with the optical reading unit kept in touch with the medium surface is relatively recognized by a difference between the contrast state of an image captured by the optical reading unit and the initial contrast state.

According to this, an intuitive tilting operation can accurately be recognized regardless of an individual difference between lots in manufacturing the optical reading portion, an angle of the main body of the remote control device to a medium surface when the remote control device is brought in contact with the medium surface, and the like.

According to the present invention, it is possible to provide a remote control device with excellent convenience, operability, and affinity for users.

### BRIEF DESCRIPTION OF THE DRAWINGS

FIG. 1 is an in-use view of a remote control device according to the present invention.

FIG. 2 is a perspective view of the remote control device (provided with a pointing stick) according to the present invention.

FIG. 3 is a perspective view of the remote control device (provided with a arrow key) according to the present invention.

FIG. 4 is a diagram of an operation unit of the remote control device according to the present invention, the operation unit being provided with the left and right buttons of a mouse.

FIG. 5 is a block diagram showing an internal structure of the remote control device.

FIG. 6 is a diagram expressing components of a dot pattern and a positional relationship between them.

FIGS. 7A and 7B are diagrams showing examples of methods of defining information according to methods of arranging information dots, FIG. 7A is an example of representing three-bit information, and FIG. 7B is an example of an information dot having two-bit information.

FIG. 8 is a diagram showing an example of a method of defining information according to another method of arranging information dots.

FIGS. 9A to 9C are diagrams showing examples of a method of defining information according to a method of arranging a plurality of information dots per one grid. FIG. 9A is an example of arranging two information dots, FIG. 9B is an example of arranging four information dots, and FIG. 9C is an example of arranging five information dots.

FIGS. 10A to 10D are diagrams showing other arrangement examples of grids including information dots, FIG. 10A is an example of arranging six grids (2×3) in one block, FIG. 10B is an example of arranging nine grids (3×3) therein, FIG. 10C is an example of arranging 12 grids (3×4) therein, and FIG. 10D is an example of arranging 36 grids therein.

FIGS. 11A to 11C are diagrams showing examples of other dot patterns, FIG. 11A is a diagram showing a positional relationship between reference point dots, virtual reference dots and an information dot, FIG. 11B is an example of defining information according to whether or not the information dot exists on a virtual reference dot, and FIG. 11C is a diagram showing an example in which two blocks are connected with each other vertically and horizontally.

FIGS. 12A to 12C are diagrams showing examples of formats of a dot code, FIG. 12A is an example in which the dot code includes a code value and parity, FIG. 12B is an example in which the dot pattern includes an X-Y coordinate, a code value and parity, and FIG. 12C is an example in which the dot code includes an X-Y coordinate and parity.

FIGS. 13A and 13B are diagrams illustrating a medium and a display in which dot patterns are provided above icons.

FIGS. 14A and 14B are diagrams illustrating an information input assisting sheet used with a medium and a display.

FIGS. 15A and 15B are diagrams illustrating a medium on which dot patterns are printed with icons superimposed thereon and a display on which dot patterns are displayed with icons superimposed thereon.

FIGS. 16A and 16B are diagrams illustrating an information input assisting sheet on which graphics are printed.

FIGS. 17A to 17D are diagrams illustrating the remote control device on which a plurality of infrared transmission units is provided.

FIGS. 18A and 18B are diagrams illustrating a function for transmitting a plurality of infrared codes at once.

FIG. 19 is a diagram illustrating an infrared code table.

FIG. 20 is a diagram illustrating a repeat function of a transmission button.

FIGS. 21A and 21B are diagrams illustrating designs of arrow keys provided in the operation unit.

FIGS. 22A to 22D are diagrams illustrating designs of an enter key provided in the operation unit.

FIGS. 23A to 23D are diagrams illustrating a pointing stick provided on the operation unit and arrangements thereof.

FIGS. 24A to 24D are diagrams illustrating an operation for selecting and determining an item by tilting the remote control device to an operator's side or the opposite side to the operator and an image captured by touching a medium.

FIGS. 25A to 25D are diagrams illustrating an operation for selecting and determining an item by tilting the remote control device laterally and an image captured by touching a medium.

FIGS. 26A and 26B are diagrams illustrating a captured image in a case where the remote control device and a medium are not in touch with each other.

FIGS. 27A and 27B are diagrams illustrating movement of a cursor.

FIGS. 28A and 28B are diagrams illustrating the remote control device with the infrared transmission unit provided at an upper end.

FIGS. 29A and 29B are diagrams illustrating the remote control device in which the infrared transmission unit is provided at an upper end of the remote control device, and a plurality of LEDs is provided inside the infrared transmission unit.

FIGS. 30A to 30D are diagrams illustrating the remote control device in which the infrared transmission unit is provided in the vicinity of the operation unit, and a convex mirror surface unit is provided in two-dimensional directions inside the infrared transmission unit.

### DETAILED DESCRIPTION OF THE INVENTION

The best mode for carrying out the invention is described by reference to the drawings.

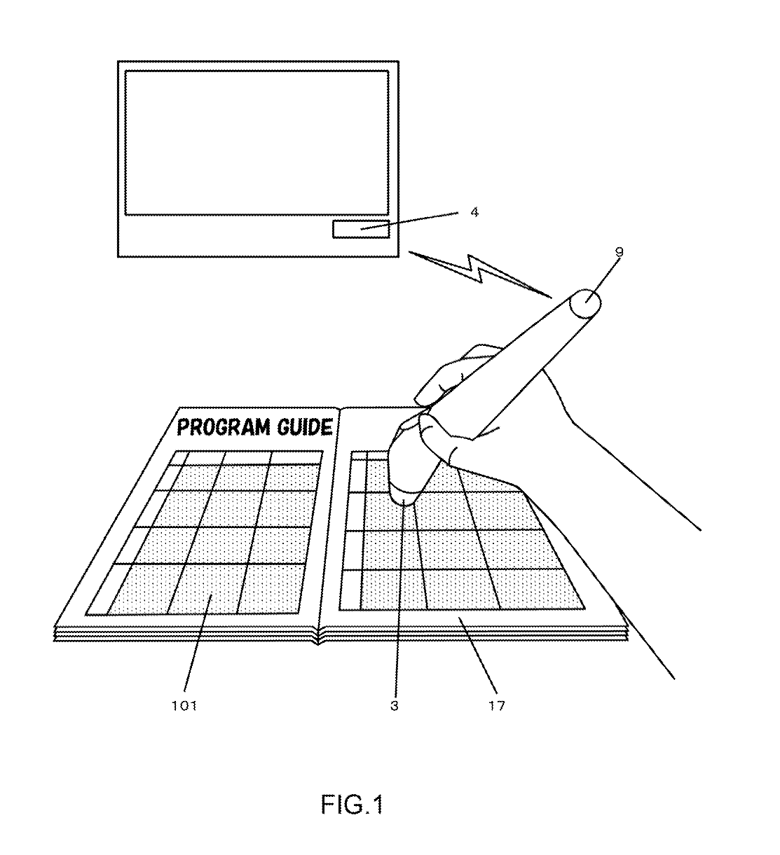

FIG. 1 is a diagram illustrating a use situation of a remote control device 1 that is an embodiment of the present invention.

FIG. 1 shows an aspect where a television which is a controlled apparatus is being operated using the remote control device 1.

As shown in FIG. 1, a user prepares a medium 17 (a program guide in FIG. 1), such as a booklet for operation, a program guide or a program listing, on which a dot pattern 101 is printed, and only with one-touch operation of the remote control device 1 with the medium 17, and the user can easily perform operations similar to those of a conventional infrared remote control device, such as changing channels and playing and recording a video.

Moreover, with a medium on which a program guide or a program listing is superimposed and printed with the dot pattern 101, only by touching the remote control device 1 to an area printed with a desired program description, program photograph or program listing, programmed recording of a program, viewing of a program, purchasing of a program, downloading of program content through VOD (video on demand) and the like can be performed, and television-shopping, Internet browsing and the like can be performed with one touch as well.

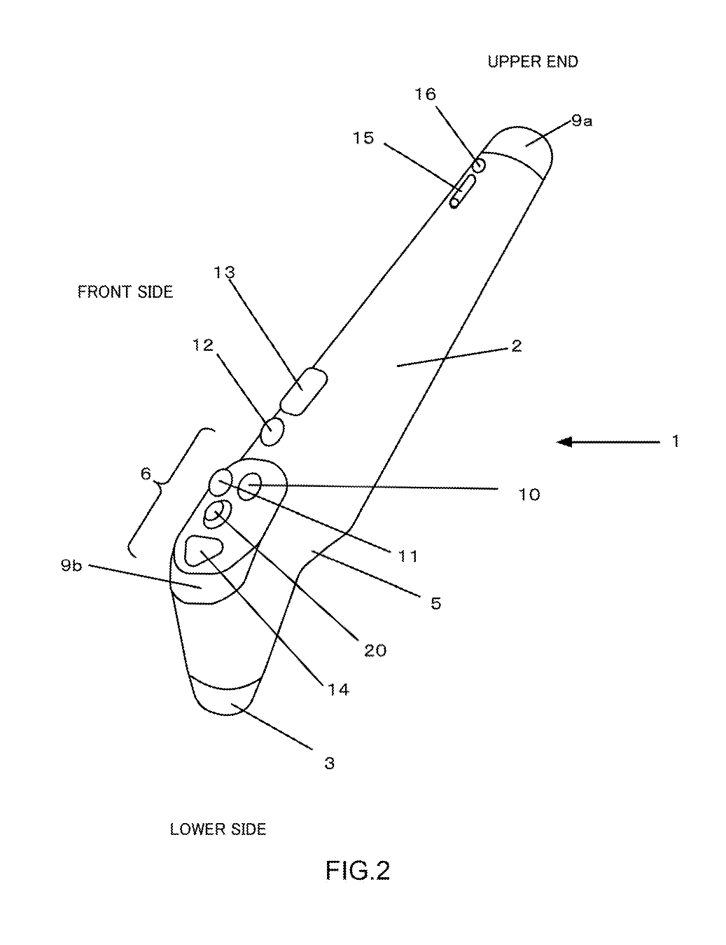

FIG. 2 is a perspective view of the remote control device 1 that is an embodiment of the present invention.

In the remote control device 1, a sensor unit (an optical reading unit) 3 is incorporated at the leading end of a device main body 2 (a lower end in FIG. 2), and, though not shown in FIG. 2, the sensor unit 3 is equipped with infrared irradiation means, such as an infrared LED, and imaging means including a CCD or a CMOS for imaging reflected light from a dot pattern that is described later.

In FIG. 2, a pointing stick 20 (pointing device) for moving a cursor and selecting an item on a screen is disposed in an operation unit 6 of the device main body 2, the cursor and the item being displayed on a screen of a display device connected with a television or a set-top box to be controlled. The pointing stick 20 has a function similar to an enter button 8 for determining a selected operation, when being pressed.

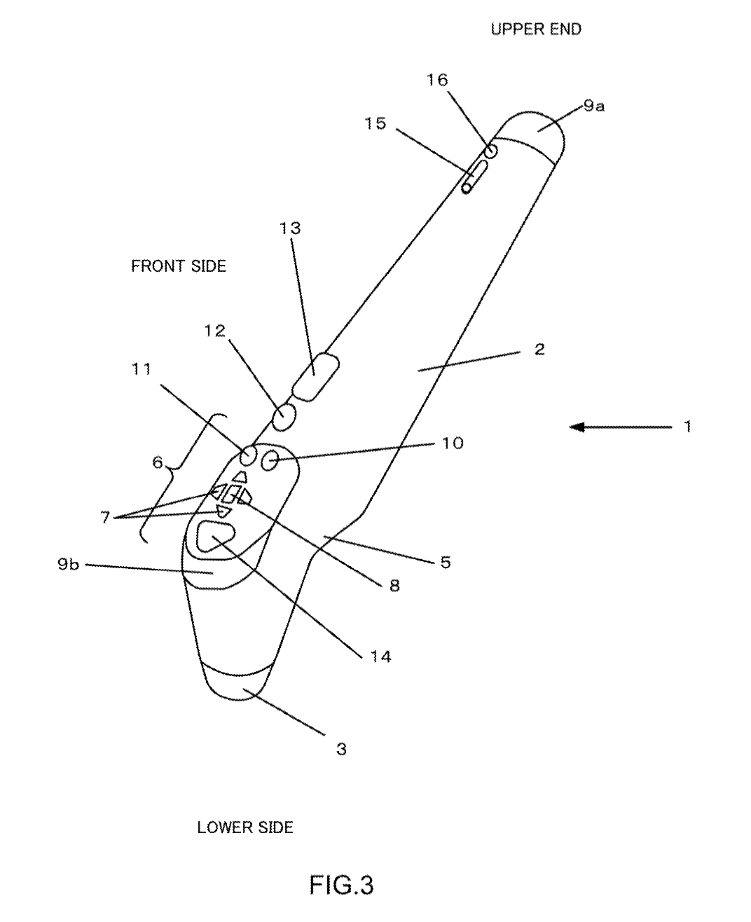

As shown in FIG. 3, arrow keys 7 the operational directions of which are vertical and horizontal directions can be disposed in place of the pointing stick 20. The enter button 8 for determining a selected operation is provided in the center of the arrow keys 7.

A menu button 10 for displaying a list of contents and/or operations (for example, a main menu) is provided above the pointing stick 20 or the arrow keys 7. In the vicinity of the menu button 10, a back button 11 for returning to the last menu display when selecting menu items sequentially is provided.

The menu button 10 and the back button 11 may have functions similar to those of the right and left buttons of a mouse. For example, the menu button 10 may have a function for calling a main menu when the button is given a long press and may have the function of the left button of a mouse when the button is given a short press. Also, the back button 11 may have a function for returning when the button is given a long press, and may have the function serving as the right button of a mouse when the button is given a short press.

The operation unit 6 is disposed at a location that allows the operation unit 6 to be operated with the remote control device 1 held like a pen or gripping-held.

The device main body 2 is provided with an infrared transmission unit 9a (transmission unit) for emitting infrared rays at its upper end portion and an infrared transmission unit 9b (transmission unit) in the vicinity of the operation unit.

A power button 12 that turns on or off a television or a set-top box to be controlled and a volume button 13 (a + button for turning up the volume and a − button for turning down the volume) are provided on a front and center portion of the device main body 2. A transmission button 14 for instructing output of an infrared signal from an infrared transmission unit 9 is provided in the operation unit 6. The transmission button 14 has a repeat transmission function for retransmitting a signal when the controlled apparatus fails to receive the signal transmitted from the infrared transmission unit 9, and/or a function for collectively transmitting a plurality of operations performed by the sensor unit 3.

It should be noted that, though in FIG. 2 and FIG. 3 the power button 12 and the volume button 13 are provided on the front and center portion of the device main body 2, they may be provided at any easily operable positions.

Further, a power switch 15 for turning on or off the remote control device 1 is provided on a front and upper portion of the device main body 2. It should be noted that, if the remote control device 1 incorporates a mechanism for activating itself automatically when any button disposed on the remote control device 1 is pressed, when the sensor unit 3 is touched to a medium surface, or when the remote control device 1 is held by hand, the power switch 15 may be eliminated.

An LED for status indication 16 is provided on a front and upper face of the remote control device 1, and it is disposed so as to visually confirm the charge status, the operation status of the sensor unit 3 and the like. It should be noted that the LED for status indication 16 may be provided, together with the power switch 15, at another position that allows easy visual confirmation.

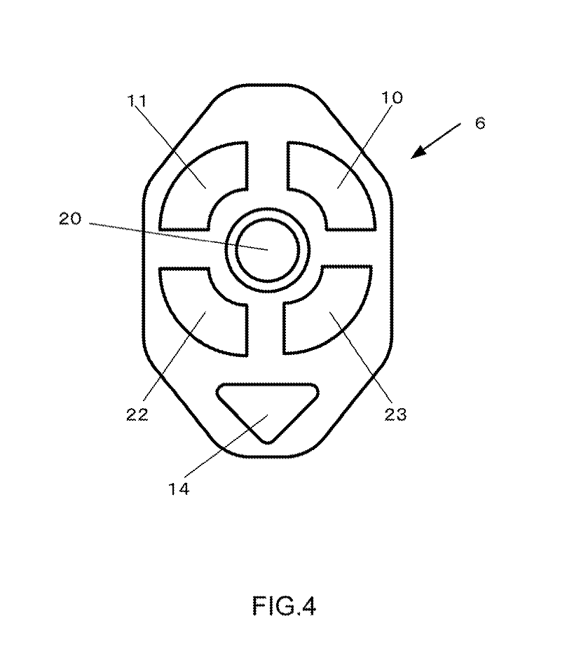

FIG. 4 is a diagram illustrating another embodiment of the remote control device 1.

Two buttons (right button 22 and left button 23) having the same functions as the right and left buttons of a mouse are provided in the operation unit 6. These buttons execute an operation corresponding to the position of the cursor 21 displayed on a display 18.

The functions similar to those of the right and left buttons of a mouse may be realized by a single button, or may be realized by more than one button.

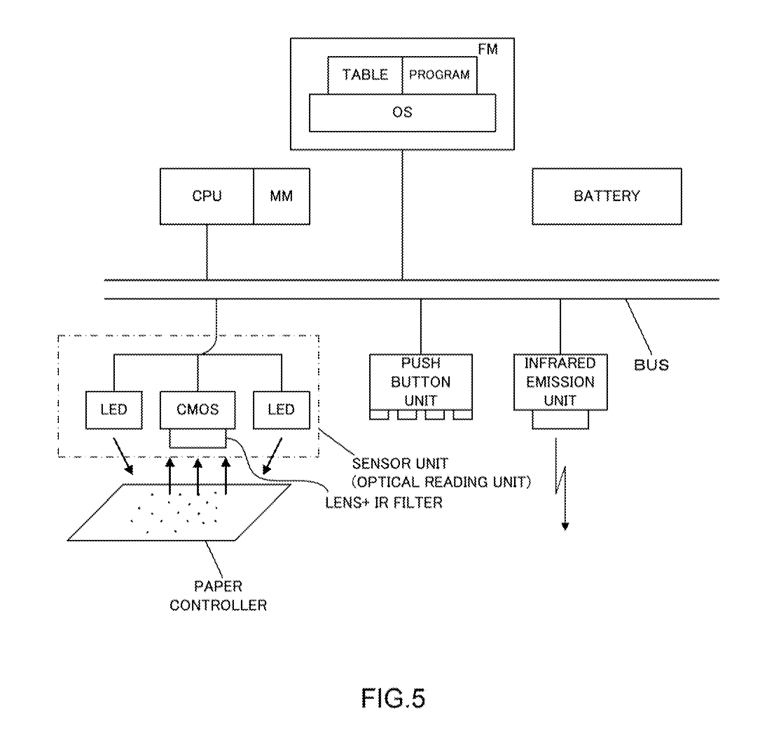

FIG. 5 is a hardware block diagram illustrating a configuration of the remote control device 1 described above.

As shown in FIG. 5, the remote control device 1 comprises a main memory (MM), a battery, a flash memory (FM) connected through a bus, an infrared transmission unit 9, a push button unit (operation unit), and a sensor unit 3 (optical reading unit), centering on a central processing unit (CPU).

The flash memory (FM) stores therein an operating system (OS) as well as programs, such as a dot pattern analysis program used in this embodiment, and a variety of tables, such as a dot-code to infrared-code correspondence table.

The central processing unit (CPU) performs execution processing by sequentially reading the programs in the flash memory through the bus (BUS) and the main memory (MM).

The push button unit is composed of a variety of buttons, such as the arrow keys 7, the enter button 8, the power button 12, the volume button 13 and the transmission button 14, and the pointing stick 20. When each button is pressed, the central processing unit receives a signal signifying that the button was pressed and performs processing corresponding to each button.

The battery is a power supply unit for driving the remote control device 1. In this embodiment, the battery may be a primary battery or a secondary rechargeable battery.

The sensor unit 3 is provided with an LED as infrared irradiation means, a lens, an IR filter that transmits only infrared rays with a predetermined frequency and blocks light rays with the other frequencies, and a CMOS sensor as an optical imaging device. When the LED irradiates a medium surface, the optical imaging device captures the reflected light of the irradiation light. Here, the dot pattern on the medium surface is printed with a carbon ink or a stealth ink (invisible ink) and a part other than the dot pattern is printed with an ink having a characteristic of reflecting or transmitting infrared rays, such as a non-carbon ink. It should be noted that, if light-permeable ink is used, infrared rays transmitted by the ink are reflected from the medium surface, transmitted by the ink again and captured by the optical imaging device.

Since the carbon ink and the stealth ink (invisible ink) have a characteristic of absorbing infrared rays, and only reflected light from dot parts cannot be obtained, and the parts are shown up in black in the image captured by the optical imaging device.

Here, as for the irradiation light, though a case where infrared rays are used and a dot pattern printed with a carbon ink and a stealth ink (invisible ink) is used is described in this embodiment, irradiation light and an ink characteristic are not limited to them, for example, ultraviolet rays or light rays with a predetermined frequency may be used, and a dot pattern may be printed with an ink having a characteristic of absorbing ultraviolet rays or a characteristic of changing in optical property.

A code value and/or a coordinate value are/is calculated from the captured image of the dot pattern read out in this manner by the dot pattern analysis program running in the central processing unit (CPU) in the remote control device 1 and are/is converted into a predetermined infrared code and transmitted to the infrared reception unit 4 of a television or a set-top box through the infrared transmission unit 9.

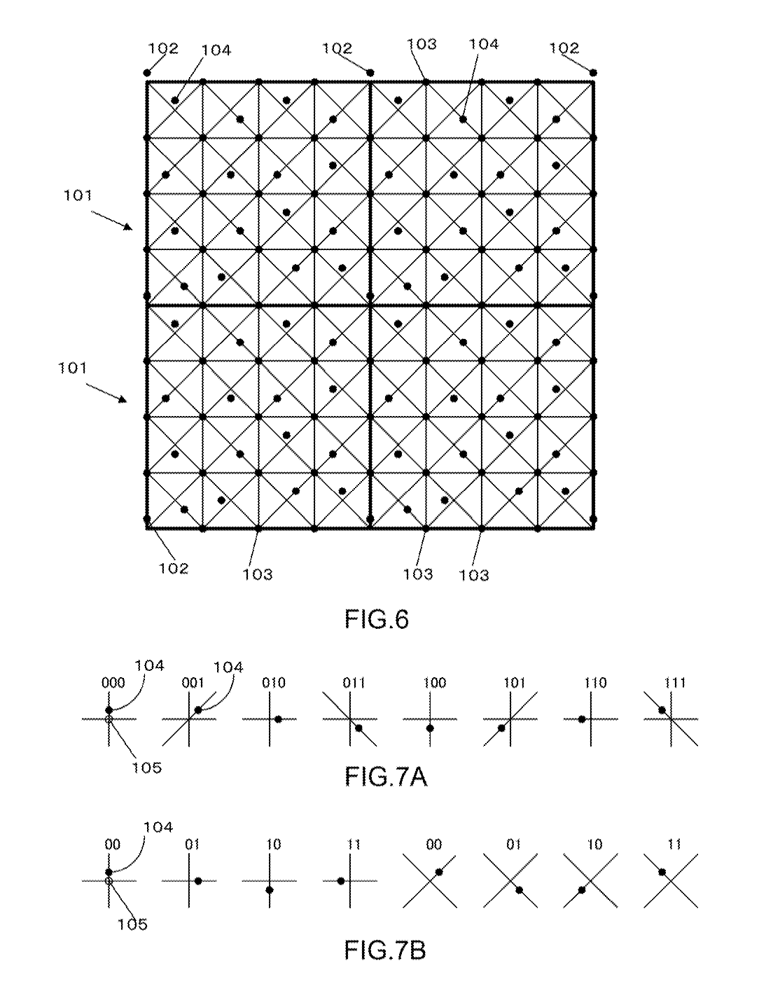

FIG. 6 to FIG. 11 are diagrams illustrating the dot pattern 101

### <Description of Dot Pattern GRID1>

With reference to FIG. 6 to FIG. 10, a dot pattern referred to as GRID1 is described as an example of the dot pattern 101 used in this embodiment. It should be noted that, in these figures, vertical, horizontal and diagonal grid lines are added for convenience of description, and do not exist in an actual printing surface.

Components of the dot pattern 101 and a positional relationship of the components are shown in FIG. 6. The dot pattern 101 comprises key dots 102, reference grid point dots 103 and information dots 104.

The dot pattern 101 is generated, based on a dot code generation algorithm, by arranging fine dots for recognition of numerical information, namely, key dots 102, reference grid point dots 103 and information dots 104 in accordance with a predetermined rule.

As shown in FIG. 6, a block of a dot pattern 101 representing information is configured such that 5×5 reference grid point dots 103 are arranged with reference to the key dots 102, and an information dot 104 is arranged around a virtual grid point 105 which is at the center surrounded by four reference grid point dots 103. Arbitrary numerical information is defined in this block. Incidentally, the illustrative example of FIG. 6 shows a case where four blocks of the dot patterns 101 (within thick frames) are arranged in parallel. However, it is obvious that the dot pattern 101 is not limited to four blocks.

As shown in FIG. 6, the key dots 102 are dots obtained by unidirectionally shifting four reference grid point dots 103 at four corners of the block. The key dots 102 are representative points of the dot pattern 101 for one block including the information dots 104. For example, they are points obtained by shifting the reference grid point dots 103 at the four corners of the dot pattern 101 upward by 0.1 mm. However, the numerical value is not limited to this value, and it is variable according to the size of a block of the dot pattern 101.

In order to avoid mistaking the reference grid point dots 103 for the information dots 104, the shift amount of the key dots 102 is preferably around 20% of a grid interval.

The information dot 104 is a dot that is used for recognition of various information. The information dot 104 is arranged around the key dot 102 using the key dot 102 as a representative point, and arranged at an end point expressed by a vector using a virtual grid point 105 which is the center of a grid surrounded by four reference grid point dots 103 as a starting point.

The space between the information dot 104 and the virtual grid point 105 that is surrounded by four reference grid point dots 103 is preferably a space of approximately 15% to 30% of a distance from an adjacent virtual grid point 105. This is because, if the distance between the information dot 104 and the virtual grid point 105 is shorter than the space, the dots are easily recognized visually as one big cluster, which is visually undesirable as the dot pattern. And this is also because, if the distance between the information dot 104 and the virtual grid point 105 is longer than the space, it becomes difficult to recognize which adjacent virtual grid point 105 is used as the starting point of the vector whose directionality is given to the information dot 104.

When the dot pattern 101 is retrieved as image data by using the sensor unit 3, the reference grid point dots 103 can calibrate distortion of a lens of the sensor unit 3, skewed imaging, expansion and contraction of a paper surface, curvature of a medium surface and distortion at the time of printing. Specifically, a function for correction (Xn, Yn)=f(Xn′, Yn′) is calculated for converting distorted four reference grid points 103 into the original square, and the vector of a correct information dot 104 is calculated by correcting the information dot 104 using the same function.

When the reference grid point dots 103 are arranged in the dot pattern 101, since a distortion caused due to the sensor unit 3 is corrected in image data in which the dot pattern 101 has been retrieved by the sensor unit 3, the arrangement of dots can accurately be recognized even if image data of the dot pattern 101 is retrieved by a common sensor unit 3 with a lens whose distortion rate is high. Also, even if the dot pattern 101 is read by the sensor unit 3 inclining with respect to the surface of the dot pattern 101, the dot pattern 101 can accurately be recognized.

When dot reading by infrared irradiation is performed by the sensor unit 3, the key dots 102, the information dots 104 and the reference grid point dots 103 are preferably printed with an invisible ink or a carbon ink that absorbs infrared light.

When a relatively fine dot pattern 101 is printed by an ordinary ink-jet printer, the interval between the reference grid point dots 103 (namely, grid size) may be about 0.5 mm at minimum. In the case of offset printing, it may be about 0.3 mm at minimum.

When an ultrafine dot pattern 101 is formed by using exposure technology and the like in a semiconductor manufacturing process, the interval between the reference grid point dots 103 may be about a few μm, or, if a micrometer design rule is used, a dot pattern 101 having much finer dot intervals can be formed.

Obviously, as long as the interval between the reference grid point dots 103 is the above minimum value or larger, any value may be used according to intended use of the dot pattern 101.

In addition, the diameters of the key dots 102, the information dots 104 and the reference grid point dots 103 are preferably about 10% of the interval between the reference grid point dots 103.

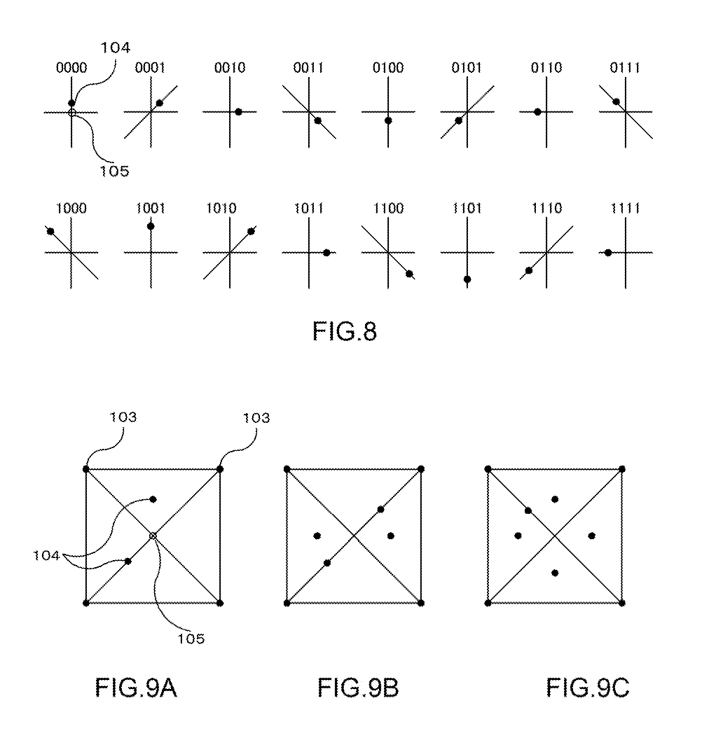

Examples of methods for defining information according to methods for arranging the information dots 104 are shown in FIGS. 7A and 7B and FIG. 8. These figures are enlarged views showing examples of positions of the information dots 104 and bit representations of information defined according to the positions.

FIG. 7A shows an example of a defining method for representing 3-bit information as the information dots 104 arranged in eight different directions by shifting the information dots 104 from the virtual grid points 105 (for example, by 0.1 mm) and rotating them by every 45 degrees in a clockwise direction such that the information dots 104 have directions and lengths represented by vectors. In this example, since the dot pattern 101 includes 16 information dots 104 per one block, the dot pattern 101 can represent 3 bits×16=48-bit information.

FIG. 7B shows an example of a method for defining the information dots 104 such that the dot pattern 101 has 2-bit information per each grid. In this example, 2-bit information per information dot 104 is defined by shifting the information dots 104 from the virtual grid points 105 in a plus (+) direction and in a diagonal (×) direction. Unlike the defining method (that can define 48-bit information originally) shown in FIG. 7A, this defining method can give 32-bit (2 bits×16 grids) data, according to intended use, by dividing one block into grids in which the information dots 104 are shifted in the plus (+) direction and grids in which the information dots 104 are shifted in the diagonal (×) direction.

It should be noted that 216 (approximately 65,000) dot pattern formats can be realized at maximum by combining the method of shifting in the plus (+) direction and the method of shifting the diagonal (×) direction for each grid, as combinations of directions in which the information dots 104 arranged in 16 grids included in one block are shifted.

FIG. 8 shows an example of the information defining method according to another method for arranging the information dots 104. In this defining method, when the information dots 104 are arranged, two long and short shift amounts from the virtual grid points 105 surrounded by the reference grid point dots 103 are used and 8 vector directions are used, so that 16 arrangements can be defined, and therefore 4-bits information can be represented.

When this defining method is used, it is preferred that the long shift amount is set at about 25% to 30% of the distance between adjacent virtual grid points 105, and the short shift amount is set at about 15% to 20% thereof. It should be noted that, in order to separately recognize long and short information dots 104 even if these long and short information dots 104 are shifted in the same direction, the space between the centers of these information dots 104 is preferably wider than the diameter of the information dot 104.

It is obvious that a method for defining 4-bit information is not limited to the above defining method and can variously be varied, and it is also possible to represent 4 bits by arranging the information dots 104 in 16 directions.

FIG. 9A to 9C show examples of methods for defining information according to a method for arranging a plurality of information dots 104 per one grid. FIG. 9A shows an example in which two information dots 104 are arranged, FIG. 9B shows an example in which four information dots 104 are arranged, and FIG. 9C shows an example in which five information dots 104 are arranged.

The number of information dots 104 per one grid surrounded by four reference grid point dots 103 is preferably one in consideration of visual quality. However, in a case in which the amount of information is desired to be increased regardless of visual quality, a large amount of information can be defined by allocating one bit to each vector and using a plurality of dots as information dots 104 to represent the information. For example, vectors in eight directions in a concentric circle can represent 28 information per one grid, and therefore they can represent 2128 information per one block including 16 grids.

The dot pattern 101 is recognized, after the dot pattern 101 is retrieved as image data by the sensor unit 3, by first extracting the reference grid point dots 103, then extracting the key dots 102 according to the fact that there is no dot at positions where the reference grid point dots 103 should exist, and then extracting the information dots 104.

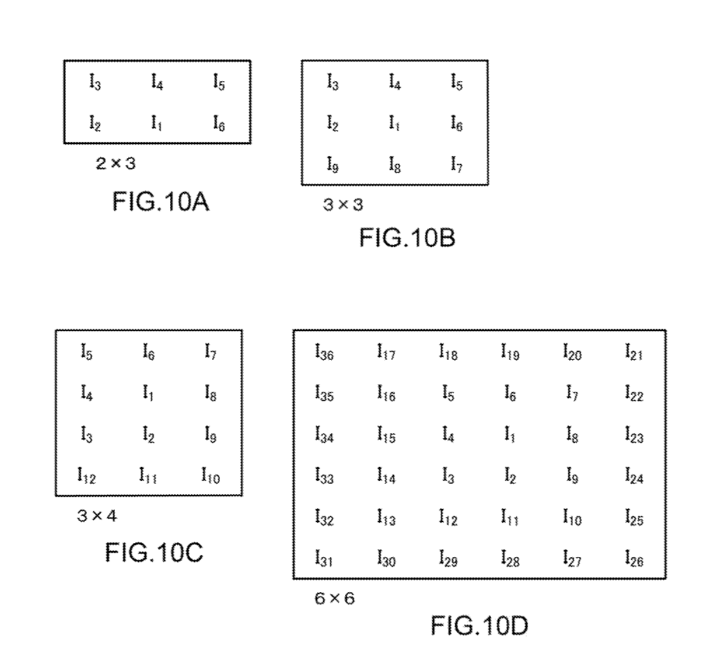

FIGS. 10A to 10D show other arrangement examples of grids including the information dots 104. FIG. 10A shows an example in which 6 (2×3) grids are arranged in one block, FIG. 10B is an example in which 9 (3×3) grids are arranged in one block, FIG. 10C shows an example in which 12 (3×4) grids are arranged in one block, and FIG. 10D shows an example in which 36 grids are arranged in one block. In this manner, in the dot pattern 101, the number of grids included in one block is not limited to 16, and can variously be varied.

That is, by adjusting the number of grids included in one block and the number of information dots 104 included in one grid according to the amount of information required and the resolution of the sensor unit 3, the amount of information that can be recorded in the dot pattern 101 can flexibly be adjusted.

### <Description of Dot Pattern GRID5>

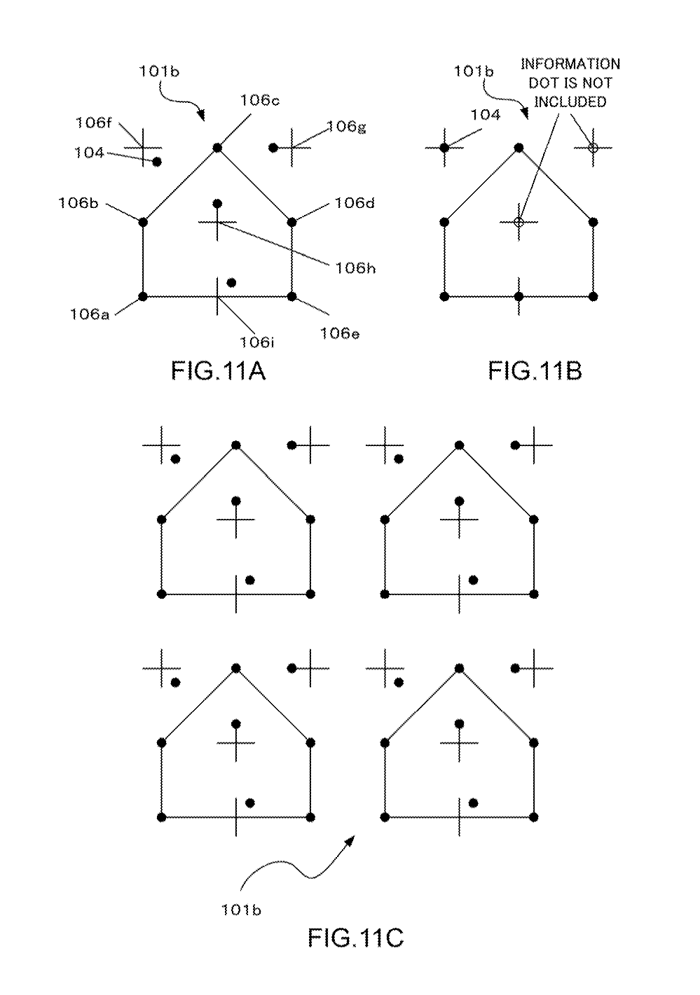

FIGS. 11A to 11C illustrate an example of another dot pattern 101b (GRID5).

FIG. 11A illustrates a positional relationship between reference point dots 106a to 106e, virtual reference points 106f to 106i and information dots 104 in the dot pattern 101b.

The dot pattern 101b is such that the direction of the dot pattern 101b is defined by the shape of a block. In GRID5, the reference point dots 106a to 106e are first arranged. The shape showing the orientation of a block (here, a pentagon pointing upward) is defined by lines connecting the reference point dots 106a to 106e sequentially with each other. Next, based on the arrangement of the reference point dots 106a to 106e, the virtual reference points 106f to 106i are defined. Next, vectors having directions and lengths using the virtual reference points 106f to 106i as starting points are defined. Finally, the information dots 104 are arranged at the end points of the vectors.

In this manner, in GRID5, the orientation of a block can be defined by arrangement of the reference point dots 106a to 106e. Then, the entire size of the block is also defined according to the definition of the orientation of the block.

FIG. 11B illustrates an example of defining information according to whether or not the information dots 104 exist on the virtual reference points 106f to 106i of a block.

FIG. 11C illustrates an example in which two blocks of GRID5 are connected with each other vertically and horizontally. However, the direction in which the blocks are connected and arranged is not limited to vertical and horizontal directions, and the blocks may be arranged and connected in any directions.

It should be noted that, in FIGS. 11A to 11C, the reference point dots 106a to 106e and the information dots 104 have the same shape, but the reference point dots 106a to 106e and the information dots 104 may have different shapes, for example, the reference point dots 106a to 106e have larger shapes than the information dots 104. In addition, the reference point dots 106a to 106e and the information dots 104 may have any shapes as long as they are identifiable, so that they may be circular, triangular, rectangular or polygonal above the rectangular.

### <Regarding Format of Dot Code>

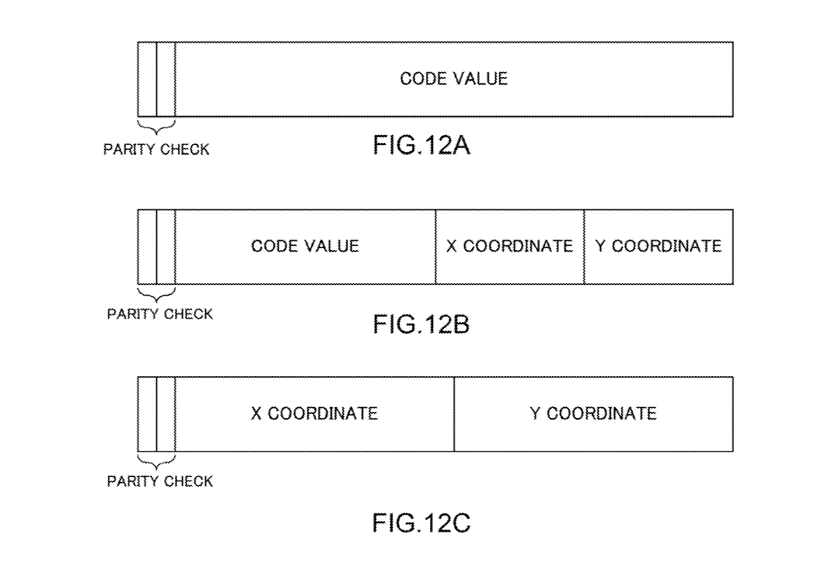

FIGS. 12A to 12C are diagrams illustrating dot code formats of the information dot 104.

FIG. 12A shows a case in which the dot pattern is composed only of code values, where the code values and a parity check are registered.

In addition, in FIG. 12B, X and Y coordinates are registered in the format together with a code value. That is, a Y coordinate, an X coordinate, code values and a parity check are registered in the format, respectively.

In this manner, in this embodiment, X and Y coordinates can be registered in the dot pattern together with code values. Thereby, it is made possible to transmit and deliver information corresponding to a position, such as delivering a picture from a map and utilizing a paper controller as a tablet.

Further, FIG. 12C shows a format in which only X and Y coordinates have been registered. The X and Y coordinates take unique values for each medium, so that commands can be transmitted by providing a table that relates coordinates to the commands.

In this manner, the format of the dot pattern of the present invention can be flexible, like the case in which only code values are registered, the case in which code values and X and Y coordinates are registered and the case in which X and Y coordinates are registered together with a coordinate index.

It should be noted that, as for the dot patterns, not only the dot patterns based on the algorithms illustrated in FIGS. 4 to 12, but any dot patterns may be used, such as the dot patterns described in Japanese Patent Application Publication (Translation of PCT Application) No. 2003-511761 and Japanese Patent Application Publication No. 2007-288756.

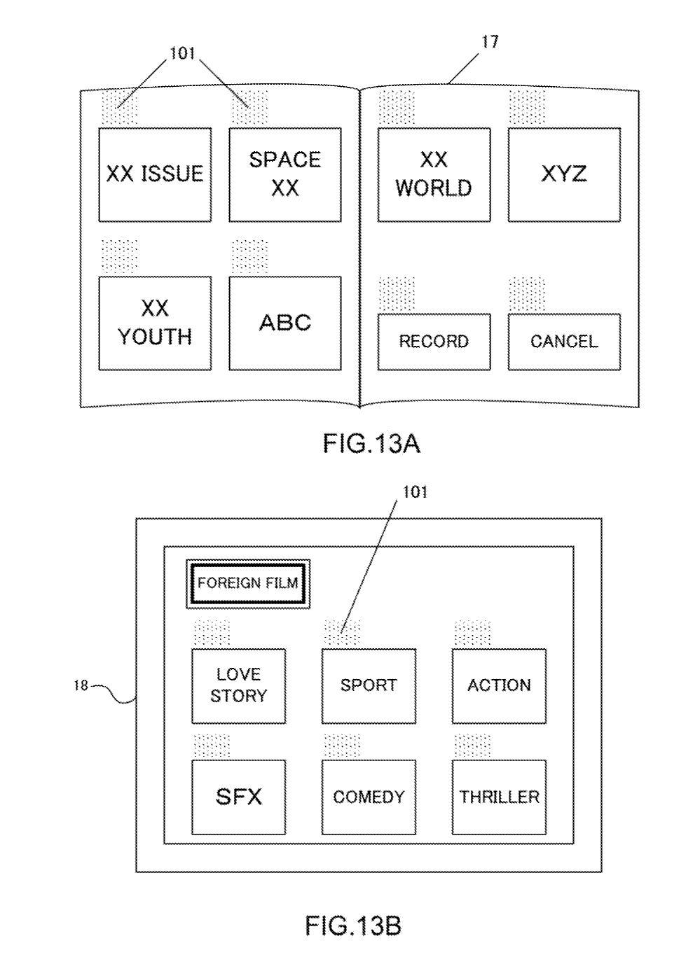

FIGS. 13A and 13B are diagrams illustrating a medium 17 and a display 18 used in the present invention.

As described above, a user performs such operations as operation of a set-top box or a television and playing of contents, by touching the medium 17 on which the dot pattern 101 is printed with the remote control device 1. FIG. 13A is a diagram illustrating such a medium 17. The medium 17 is printed with graphics, such as an icon, a text, a figure, an illustration, and a photograph, and the dot patterns 101 are printed on the same surfaces of the graphics. Each of the dot patterns 101 corresponds to one of the graphics, and if the user touches the dot pattern 101 with the remote control device 1, processing corresponding to content shown by the graphic is performed. For example, if the user touches the dot pattern 101 printed on the same surface with an icon indicating “Record,” recording of a television program or the like is performed.

FIG. 13B shows another embodiment of the present invention. In the present invention, not only the medium 17 printed with the dot pattern 101 but also the display 18 displaying the dot pattern 101 can be used.

In such a display 18, a part of the display 18 display the dot pattern 101. Then, the display 18 displays an image, such as an icon, a text, a figure, an illustration, and a photograph, corresponding to each dot pattern 101.

If a user touches the dot pattern 101 on the display 18 with the remote control device 1, then, as is the case of touching the medium 17, processing corresponding to the content of the image is performed in the controlled apparatus.

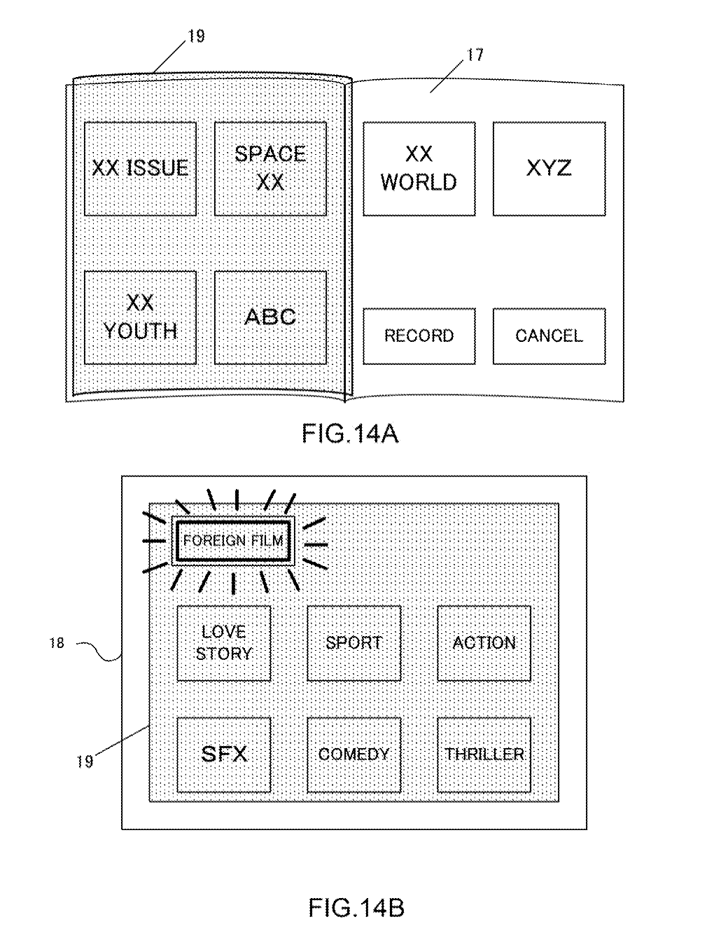

FIG. 14A is a diagram illustrating a case in which an information input assisting sheet (grid sheet 19) that is a transparent sheet printed with a dot pattern 101 is placed on the medium 17, and FIG. 14B is a diagram illustrating the case in which the grid sheet 19 is attached on the display 18.

The dot pattern 101 printed on the grid sheet 19 is made into a pattern with X and Y coordinate values and/or a code value according to a predetermined algorithm. A user touches the grid sheet 19 with the remote control device 1 in accordance with an instruction on a medium seen through the sheet or on a display screen. The remote control device 1 reads out the dot pattern 101, analyzes the dot pattern 101, calculates the X and Y coordinate values on the grid sheet 19, and further converts the X and Y coordinate values into X and Y coordinate values on the display.

Such an operation realizes touch panel style input using the grid sheet 19, and therefore it becomes possible to provide a low cost and convenient touch panel. Further, it also becomes possible to perform an operation as browsing information to which link information is not set, when browsing Internet sites, by searching relevant information. For such cases, the remote control device 1 provides an optimal embodiment.

As for the structure of the grid sheet 19, the grid sheet 19 is formed of a transparent film and printed with the dot pattern 101. The grid sheet 19, shown in FIG. 14A, which is placed on the medium 17 to be used, is composed of a transparent infrared diffuse reflection layer, a dot pattern layer, and a transparent sheet for protection, they being layered in this order from the rear side (medium side).

The infrared diffuse reflection layer has a characteristic to diffusely reflect infrared rays and transmit visible light from one side. The infrared rays subjected to irradiation from the infrared irradiation means is first absorbed into the dot part of the dot pattern layer, but transmitted through the other regions. Next, the transmitted infrared rays are diffusely reflected from the infrared diffuse reflection layer, and transmitted through the dot part of the dot pattern layer except for the dot part.

The transparent sheet for protection is produced from material that transmits visible light and infrared rays, such as polyvinyl chloride (PVC), polyethylene terephthalate (PET), and polypropylene (PP). If the remote control device 1 repeatedly touches the dot pattern 101, the dots are worn out, raising a problem where the dot pattern 101 cannot be accurately read. Thus, the transparent sheet for protection is provided to prevent the dots from wearing out and becoming dirty so that the sheet can be used for a long term.

Moreover, the grid sheet 19 shown in FIG. 14B, which is attached on the display 18 to be used, is composed of an adhesive layer, an infrared diffuse reflection layer, a dot pattern layer, and a transparent sheet for protection in this order from the rear side (from the display 18 side).

The adhesive layer is produced from removable material. Having such an adhesive layer allows the grid sheet 19 to be easily attached on the display 18.

Descriptions of the infrared diffuse reflection layer, the dot pattern layer, and the transparent sheet for protection are omitted, as these are the same as those used for the grid sheet 19 used with the medium 17.

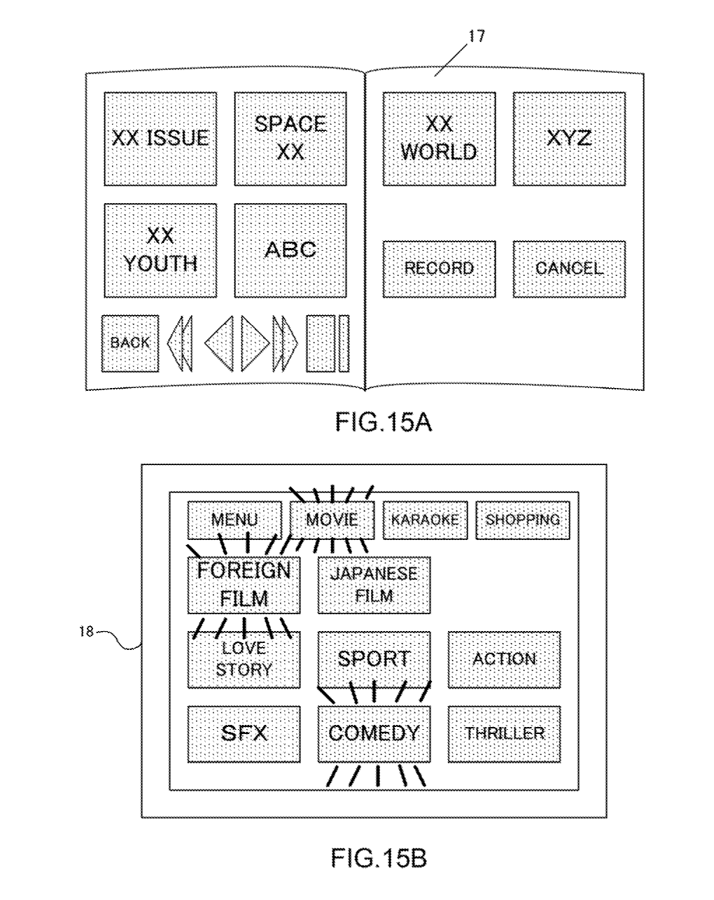

FIGS. 15A and 15B are diagrams showing other embodiments of the medium 17 with a dot pattern 101 printed thereon and the display 18 with a dot pattern 101 displayed thereon. In FIG. 15A, graphics, such as an icon, a text, a figure, an illustration, and a photograph, and a dot pattern 101 are superimposed and printed on the printed surface. In FIG. 15B, a dot pattern 101 together with still images or motion images, such as an icon, a text, a figure, an illustration, and a photograph is superimposed and displayed on the display 18.

In this way, the dot pattern 101 can be superimposed and printed or displayed on a graphic.

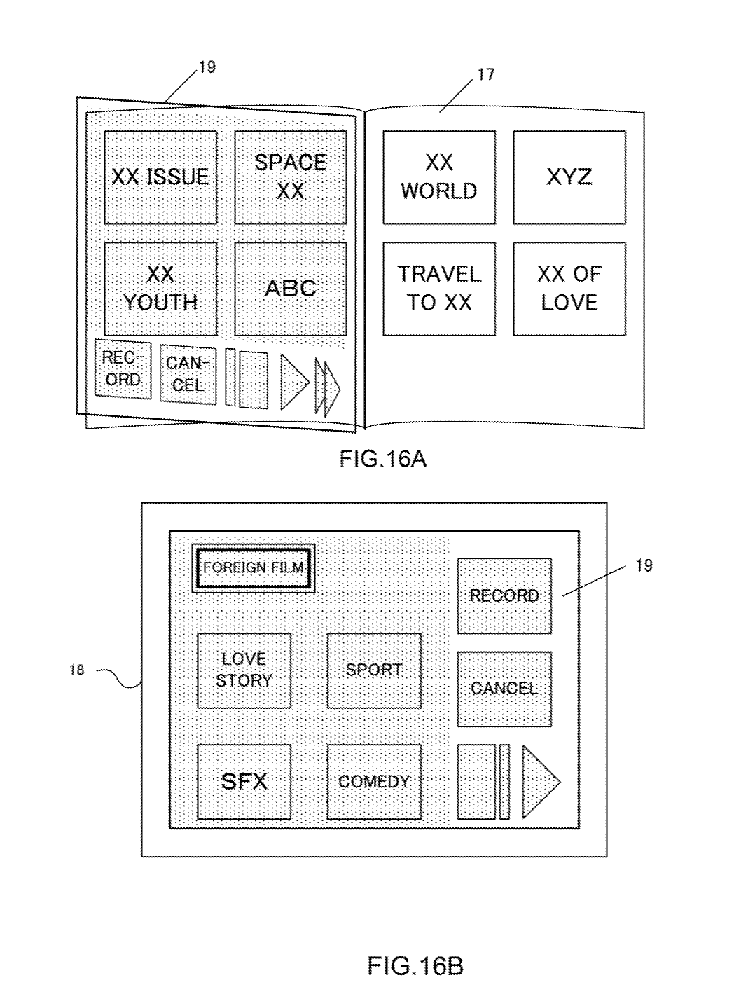

FIGS. 16A and 16B are diagrams illustrating a case in which graphics are printed on the grid sheet 19. FIG. 16A is a diagram showing a state where the grid sheet 19 is disposed on the medium 17, and graphics, such as RECORD and CANCEL, are superimposed and printed at the bottom. FIG. 16B is a diagram showing a state where the grid sheet 19 is attached on the display 18, and graphics, such as RECORD and CANCEL, are superimposed and printed on the right side.

In this way, the grid sheet 19 can be superimposed and printed with the dot pattern 101 and a graphic.

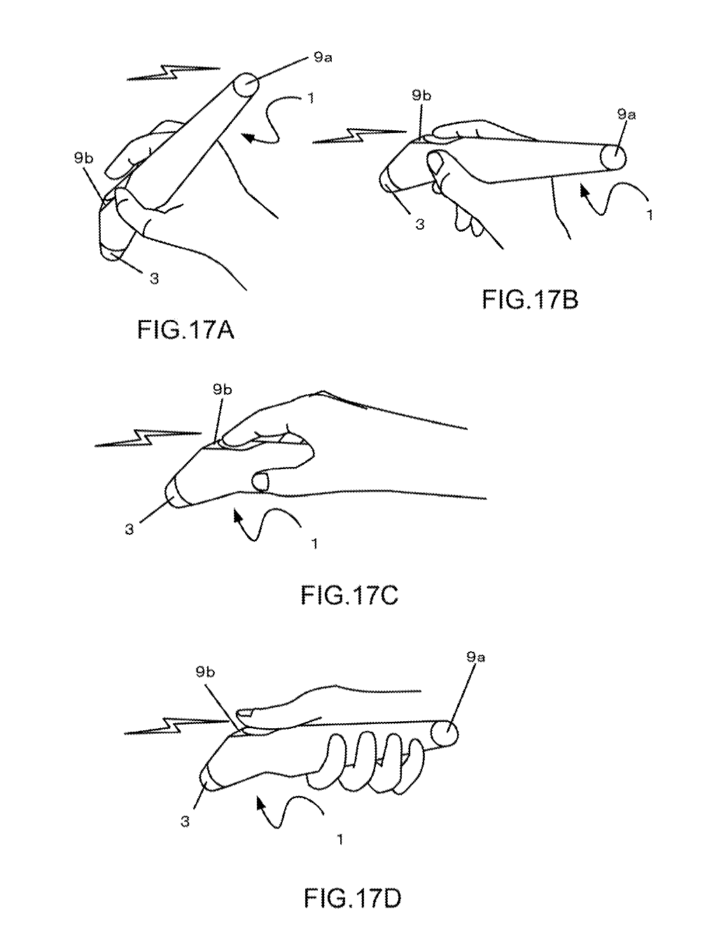

FIGS. 17A to 17D are explanatory diagrams showing infrared transmission units 9a and 9b (transmission units). As shown in FIGS. 17A to 17D, the first infrared transmission unit 9a is provided on top of the device main body 2, and the second infrared transmission unit 9b is provided in the vicinity of the operation unit 6.

Since a plurality of the infrared transmission units 9a and 9b are provided in this way, when a user holds the remote control device 1 like a pen and controls the controlled apparatus touching the dot pattern 101 on the medium 17 with the remote control device 1, as shown in FIG. 17A, the infrared rays can be transmitted from the infrared transmission unit 9a to the infrared reception unit 4 of the controlled apparatus, without being interfered with by a hand or a finger with which the user performs operations.

Also, when a user holds the remote control device 1 like a pen and directs the sensor unit 3 to the controlled apparatus to send a signal, as shown in FIG. 17B, or when a user gripping-holds the remote control device 1 and operates the operation unit 6 to send a signal to the controlled apparatus, as shown in FIGS. 17C and 17D, the infrared rays can reliably be transmitted from the infrared transmission unit 9b to the infrared reception unit 4, and therefore it is possible to send a signal easily regardless of the user's way of holding the remote control device 1 or the orientation thereof.

It should be appreciated that, since the remote control device 1 has the above-described feature, the remote control device can be used, as a remote control device that is easy to operate and excellent in convenience and affinity for users, not only with a controlled apparatus using dot patterns but also with a controlled apparatus, such as an existing television or a set-top box which does not use a dot pattern.

FIGS. 18A and 18B are diagrams illustrating a function for transmitting infrared rays. When a user touches the dot pattern 101 with the optical reading unit 3 of the remote control device 1, the CPU in the remote control device 1 converts the read dot pattern 101 into a dot code, refers to an infrared code table (the details are described later) registered in the FM (flash memory), and reads out an infrared code corresponding to the dot code. If the user consecutively touches a plurality of the dot patterns 101, the read dot codes are converted into the infrared codes and sequentially stored in the memory. Then, when the user presses the transmission button 14, the CPU of the remote control device 1 sequentially transmits a plurality of the infrared codes stored in the memory toward the infrared reception unit 4 of the controlled apparatus.

In this way, the remote control device 1 according to the present invention can first store a plurality of the infrared codes in the memory in the remote control device 1, and, later, output and transmit the codes collectively. As a user can consecutively read dot patterns with the optical reading unit, convert them into transmission codes, and then transmit one or more signals collectively, the user does not have to confirm if the infrared code has been received by the infrared reception unit 4 each time he/she touches one dot pattern 101, and therefore it is possible to provide the remote control device 1 with excellent convenience and operability.

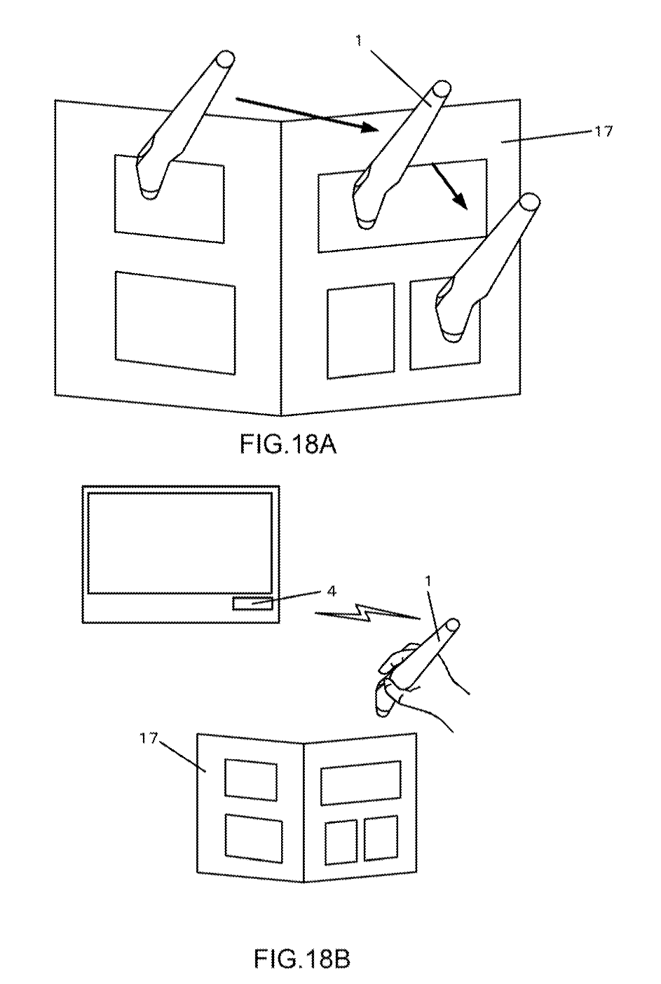

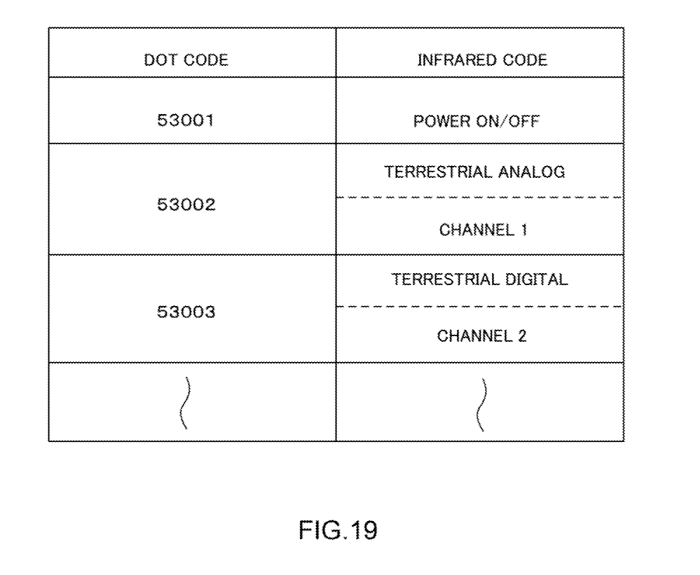

FIG. 19 is a diagram illustrating the infrared code table.

As described above, the infrared code table is registered in the FM of the remote control device 1. The infrared code table is a table indicating correspondences between the dot codes and the infrared codes. The infrared codes include operation instruction codes indicating operations of a device to be controlled such as a television. For example, when the read dot code is 53001, the operation is power on/off.

The CPU reads out the infrared code corresponding to the dot code from the infrared code table, and transmits the read infrared code from the infrared transmission unit 9 to the infrared reception unit 4 of the controlled apparatus. The television receiver performs an operation corresponding to the received infrared code, for example, processing such as turning on the power.

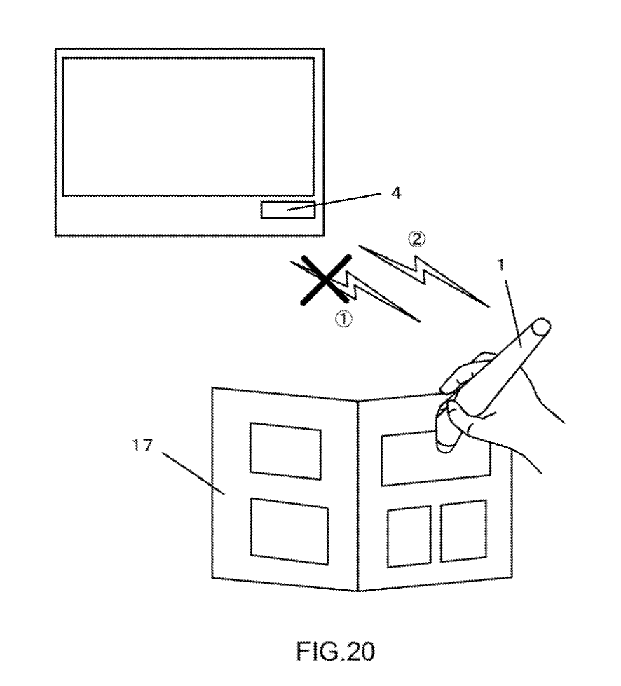

FIG. 20 is a diagram illustrating a repeat function of the transmission button 14.

If an infrared signal transmitted from the remote control device 1 does not reach the controlled apparatus, the controlled apparatus cannot perform an operation corresponding to the infrared code. In this case, if a user presses the transmission button 14, the same infrared code as the last transmitted infrared code is transmitted. Thus, the transmission button 14 has a repeat function.

As described above, the remote control device 1 is provided with a transmission button having the repeat function. For example, even if an infrared signal is transmitted and the controlled apparatus fails to recognize the transmitted signal due to an obstacle or the like, the transmitted code can easily be retransmitted.

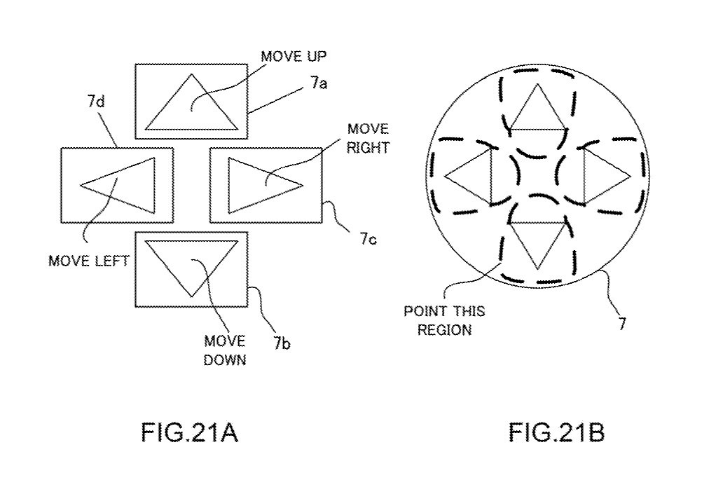

FIGS. 21A and 21B are diagrams illustrating structures of the operation unit 6.

FIG. 21A is a diagram showing a state where a plurality of arrow keys 7 operable in vertical and horizontal directions are independently disposed. The arrow key 7a disposed on top of the operation unit 6 is used when a user desires to move his/her selection upward in items on a menu display. Similarly, the arrow key 7b disposed at the bottom of the operation unit 6 is used to move his/her selection downward, the arrow key 7c disposed on the right of the operation unit 6 is used to move his/her selection rightward, and the arrow key 7d disposed on the left of the operation unit 6 is used to move his/her selection leftward.

FIG. 21B is a diagram illustrating another structure of the operation unit 6. In FIG. 21B, there is provided one arrow key 7 operable in vertical and horizontal directions and configured in an integrated manner in a ring shape. If the operator presses the upper region of the arrow key 7 integrated in a disc shape or the vicinity thereof, his/her selection in items on a menu display moves upward. Similarly, when the operator presses the lower region of the arrow key 7 integrated in a ring shape and the vicinity thereof, his/her selection moves downward, when the operator presses the left region of the arrow key 7 integrated in a ring shape his/her selection moves leftward, and, when the operator presses the right region of the arrow key 7 integrated in a ring shape and the vicinity thereof, his/her selection moves rightward.

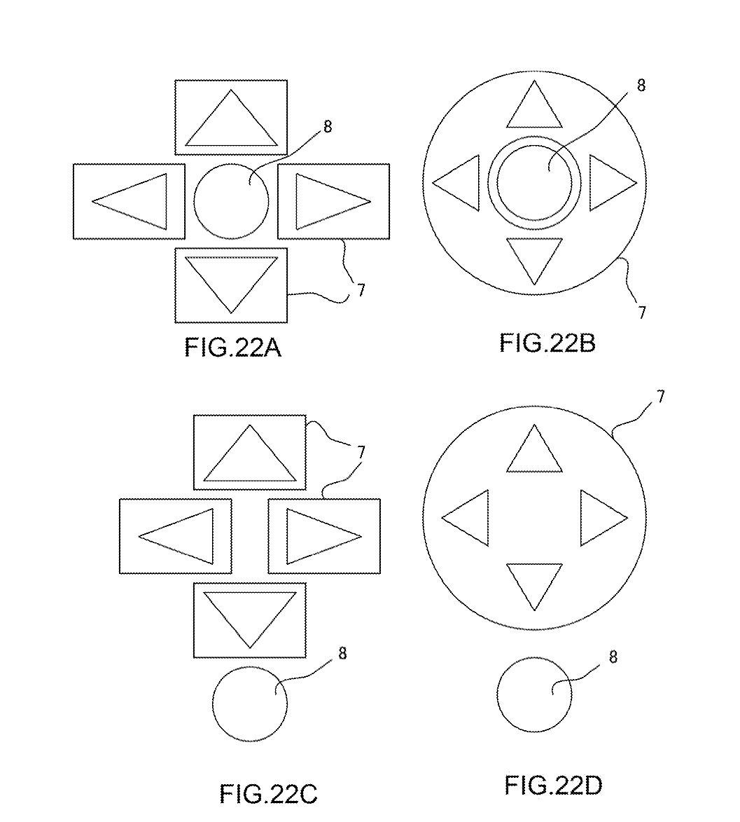

FIGS. 22A to 22D are diagrams illustrating the operation unit 6 having the enter button 8. After a predetermined operation is selected, the enter button 8 is used to determine the selected content. As shown in FIGS. 22A and 22B, the enter button 8 is provided in the middle of the arrow keys 7. Alternatively, the enter button 8 may be provided outside and near the arrow keys 7, as shown in FIGS. 22C and 22D. It should be noted that, though the enter button 8 is provided below the arrow keys 7 in FIGS. 22C and 22D, the position is not limited to this, and the enter key 8 may be provided anywhere outside and near the arrow keys 7.

Incidentally, the enter button 8 may have similar functions to the right and left buttons of a mouse.

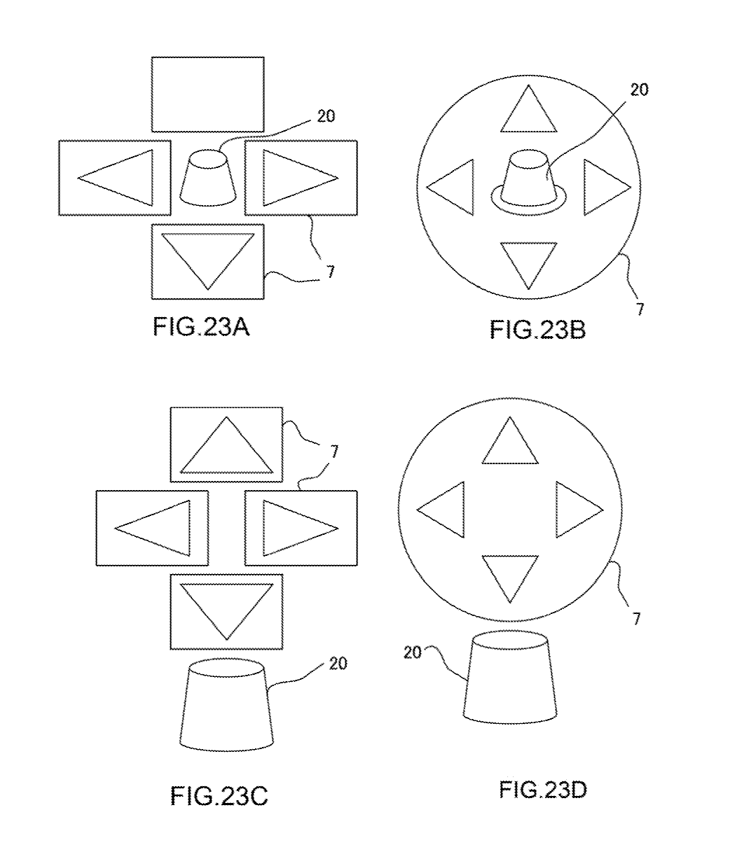

FIGS. 23A to 23D are diagrams illustrating structures of the operation unit 6 having the pointing stick 20. FIGS. 23A and 23B are diagrams illustrating cases where the stick 20 is provided in the center of the arrow keys 7, and FIGS. 23C and 23D are diagrams illustrating cases where the stick 20 is provided outside and near the arrow keys 7. It should be noted that, though in FIGS. 23C and 23D the pointing stick 20 is provided below the arrow keys 7, the position is not limited to this, and the pointing stick 20 may be provided anywhere outside and near the arrow keys 7.

A user presses the pointing stick 20 with a finger so as to tilt the same in a direction where the user desires to move the cursor displayed on the display. Moreover, the pointing stick 20 can also function as the enter button 8 if the user vertically presses the pointing stick 20 with a finger. It should be noted that only the pointing stick 20, without the arrow keys 7, may be provided to move the cursor displayed on the display and/or select and determine items.

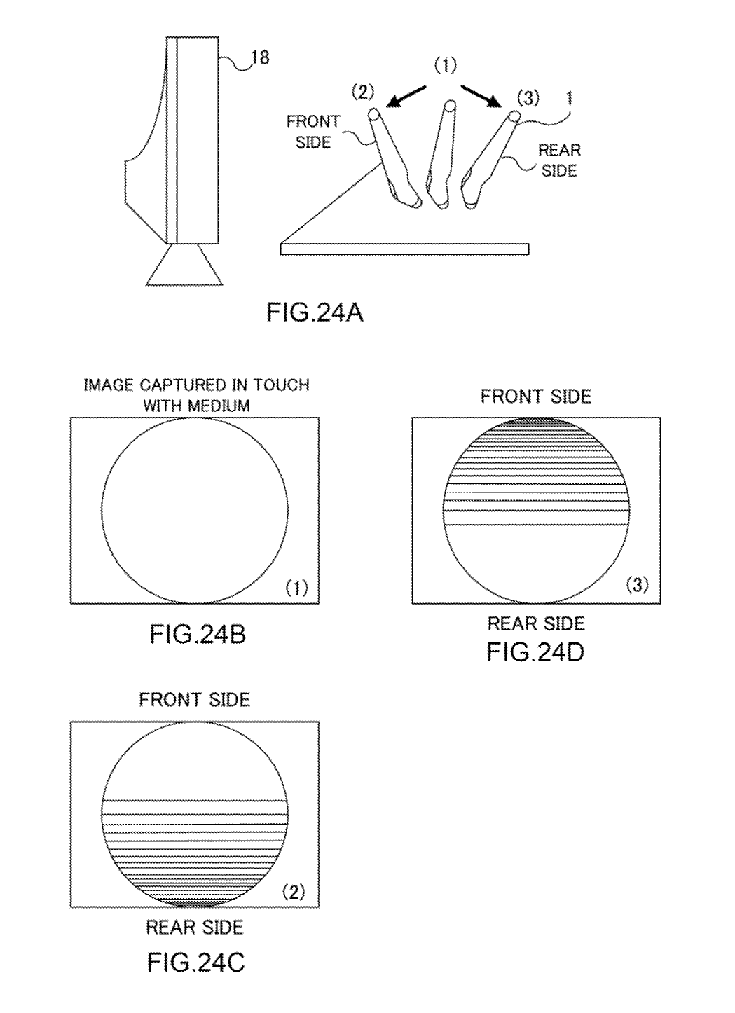

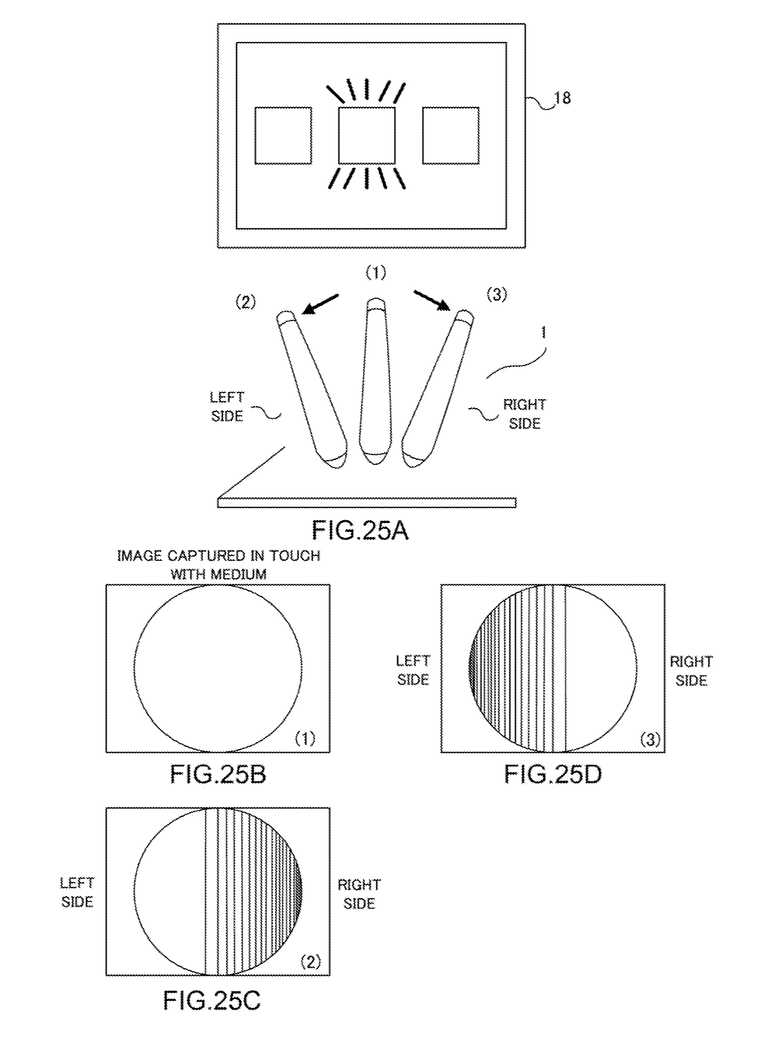

FIGS. 24A to 24D and FIGS. 25A to 25D are diagrams illustrating a method for selecting and determining an item without using the operation unit 6 described above.

In this embodiment, when a predetermined menu is displayed on the display 18, and a plurality of items in the menu are in selectable status, one of the items is selected and determined by recognizing the inclination of the longitudinal axes of the remote control device 1 within a predetermined time period.

That is, the remote control device 1 is handled like a joystick. Then, from an initial tilted state of the remote control device 1 shown by (1) in FIG. 24A, the remote control device 1 is tilted once at a predetermined angle or more in a direction opposite to an operator as shown by (2) in FIG. 24A, or tilted once at a predetermined angle or more in a direction toward the operator as shown by (3) in FIG. 24A, thereby an item that is one item above or below is selected.

Also, from the initial tilted state of the remote control device 1 shown by (1) in FIG. 25A, the remote control device 1 is tilted once at a predetermined angle or more leftward as seen from the operator as shown by (2) in FIG. 25A, or tilted once at a predetermined angle or more rightward as seen from the operator as shown by (3) in FIG. 25A, thereby an item that is one item left or right is selected.

In addition, if the remote control device 1 is returned to the initial tilted state within a predetermined time period, a standby state for executing a next operation is caused, and if the predetermined time period elapses, the items in vertical and horizontal directions are displayed and selected one after another every predetermined elapsed time until the remote control device 1 is returned to the initial tilted state.

Further, FIGS. 24B to 24D and FIGS. 25B to 25D are illustrations of another method for performing vertical and horizontal direction operations by tilting the remote control device 1.

The remote control device 1 performs calibration settings, when starting recognition of tilting of the remote control device 1, based on an initial tilted state where the remote control device 1 is generally perpendicular to the surface of the medium 17 with the sensor unit 3 touching the surface of the medium 17 and an initial contrast state which is the contrast state of an image read out by the sensor unit 3 in the initial tilted state, and relatively recognizes the change in angle when the remote control device 1 is tilted with the sensor unit 3 touching the medium surface based on the difference between the contrast state of the image captured by the sensor unit 3 and the initial contrast state. That is, as shown in FIGS. 24B to 24D and FIGS. 25B to 25D, when the remote control device 1 is tilted with the sensor unit 3 touching the medium surface, the side toward which the remote control device 1 was tilted becomes bright. Thereby, the vertical and horizontal direction operations described above can be intuitively performed.

Moreover, by recognizing tilting of the remote control device 1 relatively based on the difference between the contrast states, a sensory tilting operation can be accurately recognized regardless of the difference between individual lots generated through production of optical reading units, the angle of the main body of the remote control device with respect to the medium surface when the remote control device 1 touches the medium surface, and the like.

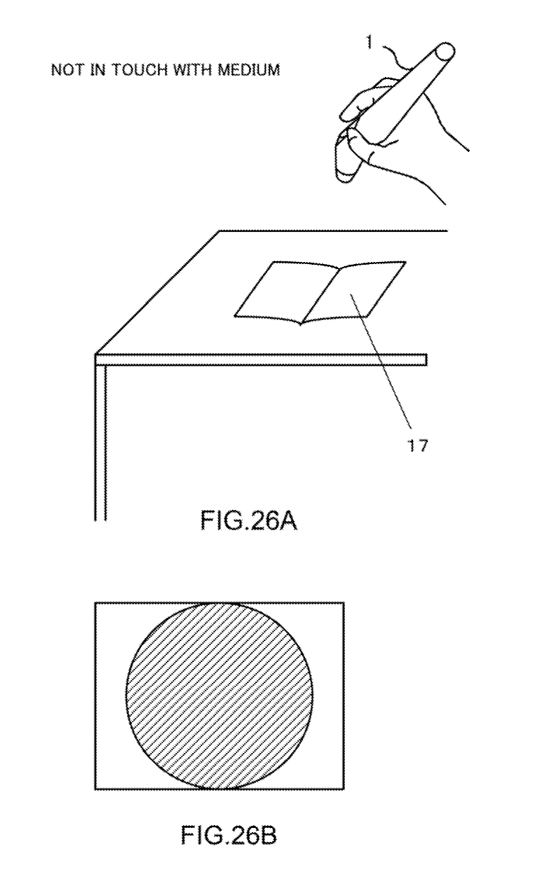

FIGS. 26A and 26B are diagrams illustrating the state of the remote control device 1 out of contact with the medium 17. In such a case as shown in FIG. 26A in which the remote control device 1 is out of contact with the medium 17, the image read out by the sensor unit 3 becomes black as shown in FIG. 26B, and any operation by the sensor unit 3, playing of content and the like become impossible.

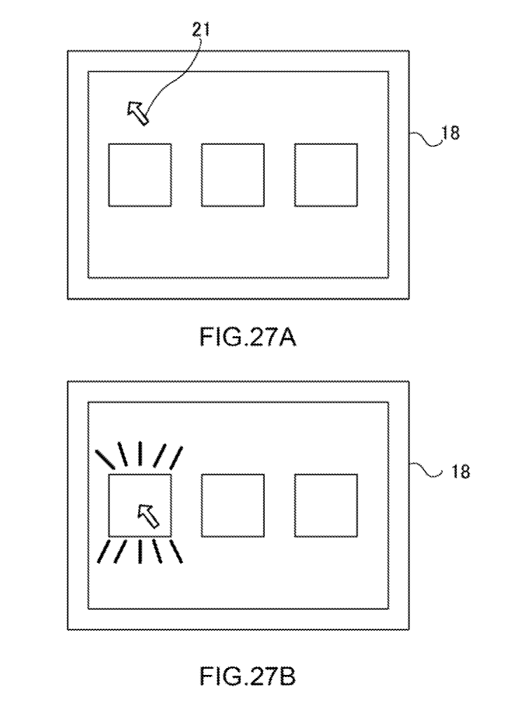

FIG. 27A and 27B are diagrams illustrating the movement of the cursor 21 when the operation shown in FIGS. 24A to 24D or FIGS. 25A to 25D is performed in the case where the cursor 21 is displayed on the display 18.

When the cursor 21 is displayed on the display 18, and a predetermined item is selected and waiting to be determined or no item is selected as shown in FIG. 27A, if the remote control device 1 is tilted at a predetermined angle or more in an arbitrary direction from the current tilted state of the remote control device 1 by handling the remote control device 1 like a joystick in the same manner as shown in FIGS. 24A to 24D or FIGS. 25A to 25D, the cursor 21 moves according to a predetermined algorithm corresponding to the angle changed by tilting in the same direction. Then, when the cursor 21 is positioned at an item as shown in FIG. 24B, the item is selected, and, if the main body is returned to the initial tilted state, the movement of the cursor 21 is stopped and the remote control device 1 is put into a standby state for executing a next operation.

Nowadays, controlled apparatuses on which the cursors 21 are displayed, such as an Internet television, are increasingly available. According to the present invention, it is possible to provide the remote control device 1 which can be operated more intuitively and easily to move the cursor 21.

### <Expansion of Infrared Transmission Region>

FIGS. 28A and 28B, FIGS. 29A and 19B and FIGS. 30A to 30D are diagrams illustrating embodiments of the remote control device 1 whose infrared transmission region is expanded.

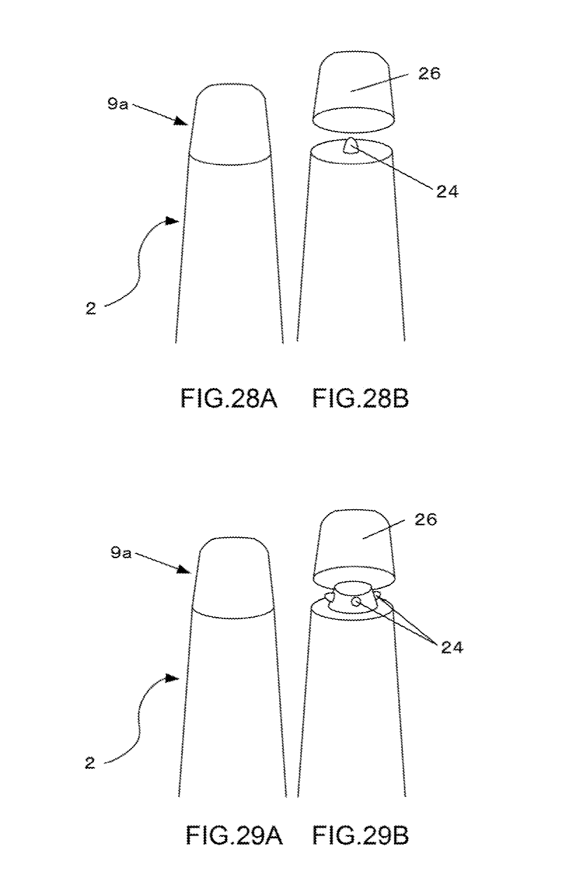

FIGS. 28A and 28B illustrate a configuration of the infrared transmission unit 9a whose infrared transmission region is expanded using an infrared light emitting device 24 that can perform omnidirectional irradiation. The infrared transmission unit 9a is provided at the upper end portion of the device main body 2. More specifically, a cap 26 made of infrared-transparent synthetic resin is attached on the upper end portion of the device main body 2. Then, as shown in FIG. 28B, the infrared light emitting device 24 is disposed in a space inside the cap 261n this case, an LED that can single-handedly perform omnidirectional irradiation is preferably used as the infrared light emitting device 24.

Such a configuration expands the transmission region of the remote control device 1.

Further, when a user holds the remote control main body like a pen and performs infrared transmission while reading the dot pattern 101 on the medium surface, the infrared transmission unit 9a is positioned at the upper most portion of the remote control device. Therefore, it is possible to perform infrared transmission without being interfered with by the user's operating finger or hand.

FIGS. 29A and 29B illustrate a configuration of the infrared transmission unit 9a using a plurality of the infrared light emitting devices 24 with normal irradiation ranges to expand the infrared transmission region. As shown in FIG. 29B, inside the infrared transmission unit 9a, the infrared light emitting devices 24 are provided at predetermined intervals along the circumferential direction about the longitudinal axis of the main body. More specifically, the cap 26 made of infrared-transparent synthetic resin is attached on the upper end portion of the device main body 2, and, inside the cap 26, the infrared light emitting devices 24 are provided at predetermined intervals in the circumferential direction about the longitudinal axis of the main body.

In this case, ordinary LEDs whose irradiating direction is approximately 60 degrees are used as the infrared light emitting devices 24.

Such a configuration can expand the transmission region of the remote control device 1 at low cost.

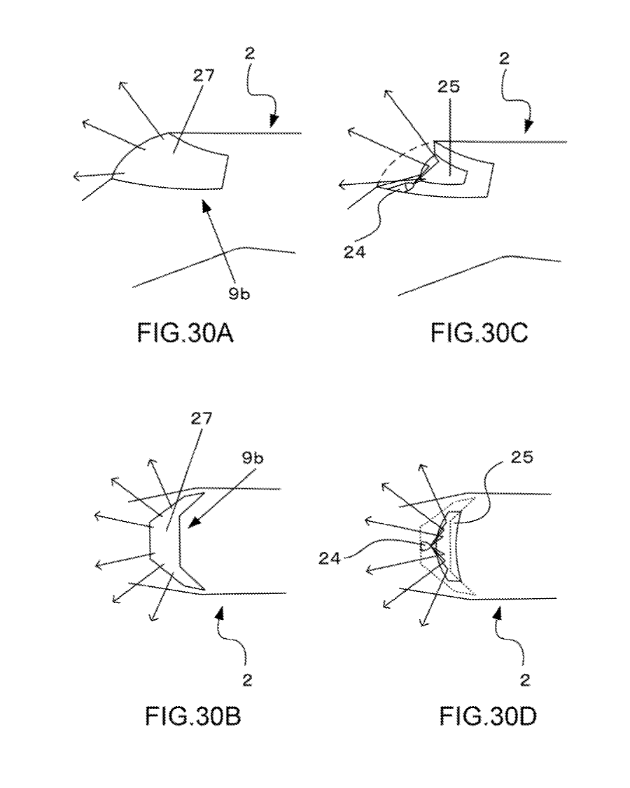

FIGS. 30A to 30D illustrate the configuration of the infrared transmission unit 9b utilizing reflection to expand the infrared transmission region.

The infrared transmission unit 9b is provided in the vicinity of the operation unit 6 of the device main body 2, and a cover 27 made of infrared-transparent synthetic resin is attached to the infrared transmission unit 9b. FIG. 30A shows a side view of the infrared transmission unit 9b, and FIG. 30B shows a top view thereof.

As shown in FIGS. 30C and 30D, one or more infrared light emitting devices 24 for performing infrared irradiation toward the device main body 2, and a convex mirror portion 25 whose surface is curved, which is provided on the side of the device main body 2, are provided in a space inside the cover 27 such that infrared rays irradiating from the infrared light emitting devices 24 are reflected in many directions from the convex mirror portion to expand the irradiation region.

As shown in FIGS. 30C and 30D, the convex mirror portion 25 may be formed in a convex shape in a three-dimensional direction along the shape of the device main body 2, or may be formed in a convex shape in a two-dimensional direction.

In addition, since the role of the convex mirror portion 25 is to expand the irradiation range utilizing the reflection of infrared rays, a diffuse reflective plate may be used in place of the convex mirror portion 25 to reflect infrared rays such that the irradiation range is expanded.

FIGS. 30C and 30D shows an example of providing only one infrared light emitting device 24 at the center of the space inside the cover 27, but the present invention is not limited to this example, and the infrared light emitting device 24 may be provided only at either one end of the space inside the cover 27. Alternatively, the infrared light emitting devices 24 may be provided at both ends of the space inside the cover 27.

Since such a structure is employed, infrared rays can accurately irradiate a controlled apparatus regardless of the orientation of the remote control device 1. Therefore, it is conventionally required to provide the infrared light emitting devices 24 (LEDs) whose infrared irradiation angle is about 60 degrees at more than one position in order to expand the irradiation region of infrared rays, but since the convex mirror portion 25 whose surface is curved is provided, it is possible to expand the irradiation region of infrared rays without increasing the number of LEDs. In addition, since the irradiation range of infrared rays can be expanded with only one LED or the fewest LEDs, it is possible to reduce the cost of components and reduce consumed power considerably.

### INDUSTRIAL APPLICABILITY

According to the present invention, a remote control device with excellent convenience, operability and affinity for users can be provided in the present time when digital broadcasts, cable televisions and Internet televisions that require complicated operations of remote control devices are widely available. Such a remote control device can be widely used to control various home electric appliances and electronic devices, and used as a new form of inputting and outputting information.

### DESCRIPTION OF NUMERALS AND SIGNS

1 REMOTE CONTROL DEVICE
2 DEVICE MAIN BODY
3 SENSOR UNIT (OPTICAL READING UNIT)
4 INFRARED RECEPTION UNIT
5 BENDING PORTION
6 OPERATION UNIT
7 ARROW KEYS
8 ENTER BUTTON
9 INFRARED TRANSMISSION UNIT
9a FIRST INFRARED TRANSMISSION UNIT
9b SECOND INFRARED TRANSMISSION UNIT
10 MENU BUTTON
11 BACK BUTTON
12 POWER BUTTON
13 VOLUME BUTTON
14 TRANSMISSION BUTTON
15 POWER SWITCH
16 LED FOR STATUS INDICATION
17 MEDIUM
18 DISPLAY
19 GRID SHEET
20 POINTING STICK (POINTING DEVICE)
21 CURSOR
22 RIGHT BUTTON OF MOUSE
23 LEFT BUTTON OF MOUSE
24 INFRARED LIGHT EMITTING DEVICE
25 CONVEX MIRROR PORTION
26 CAP
27 COVER
101 DOT PATTERN (GRID 1)
101b DOT PATTERN (GRID 5)
102 KEY DOT
103 REFERENCE GRID POINT DOT
104 INFORMATION DOT
105 VIRTUAL GRID POINT
106a-106e REFERENCE POINT DOT
106f-106i VIRTUAL REFERENCE POINT
CPU Central Processing Unit
MM Main Memory
FM Flash Memory

What is claimed is:

1. A remote control device for operating a set-top box, a mobile phone, a game console or the like connected to a television or a display device as a controlled apparatus, comprising:
a main body that can be held like a pen or gripping-held according to a user and/or a purpose of use;
an optical reading unit equipped at a bending distal end portion that is one end in the axial direction of the main body bent in an oblique direction, for reading an optically readable dot pattern that is provided on a predetermined medium surface, that is made into a pattern based on a predetermined algorithm;
a conversion unit equipped within the main body, for analyzing a dot code and/or a coordinate value from the dot pattern read out by the optical reading unit and converting the dot code and/or the coordinate value into one or more corresponding transmission codes;
an operation unit equipped in the vicinity of the origin of the bending of the main body and operable with a fingertip, for at least moving a cursor, selecting a menu, selecting a program and determining the selections being displayed on the television or the display device; and
one or more transmission units equipped in the main body, at least one of the transmission units being disposed at least in connection with the operation unit, for transmitting as signals the transmission code converted by the conversion unit and an operation instruction command provided by the operation unit to the controlled apparatus.

2. The remote control device according to claim 1, wherein the optical reading unit can optically read the dot pattern that is printed on the medium surface or displayed on a display and is made into a pattern based on the predetermined algorithm.

3. The remote control device according to claim 1, wherein the optical reading unit can optically read the dot pattern that is printed on a transparent sheet which is an information input assisting sheet placed on the medium surface or attached on a display and made into a pattern based upon the predetermined algorithm.

4. The remote control device according to claim 2, wherein the optical reading unit can optically read
the dot pattern that is superposed and printed on the medium with a still image, such as a text, a figure, an illustration or a photograph, or
the dot pattern that is superposed and displayed on the display with a still image or a motion image.

5. The remote control device according to claim 3, wherein the optical reading unit can optically read
the dot pattern that is superimposed and printed on the information input assisting sheet with a still image, such as a text, a figure, an illustration or a photograph.

6. The remote control device according to claim 1, wherein the operation unit has a transmission button with an operational function for outputting one or more signals from the transmission unit to the controlled apparatus, which is provided at a predetermined position.

7. The remote control device according to claim 5, wherein the transmission button has
a repeat function for retransmitting one or more signals when the controlled apparatus fails to recognize a signal transmitted from the transmission unit and/or
a batch transmission function a plurality of operations performed by reading the dot pattern by the optical reading unit.

8. The remote control device according to claim 1, wherein the operation unit has a pointing device used as a coordinate indication input assisting device, such as a pointing stick that can move the cursor in an arbitrary direction by an arbitrary distance and select and determine a selection item arbitrarily.

9. The remote control device according to claim 1, wherein the operation unit is equipped with
a plurality of operation buttons operable in at least vertical and horizontal directions, the buttons being independently disposed, or
a single operation button operable in at least vertical and horizontal directions.

10. The remote control device according to claim 8, wherein the operation unit is equipped with
an enter button having a function for, after a predetermined operation is selected, determining the content of the selection in the middle of or the vicinity of the plurality of operation buttons operable in at least vertical and horizontal directions, or
a pointing device that fulfills the same function as the enter button, when pressed.

11. The remote control device according to claim 8, wherein the operation unit is equipped with
an enter button having a function for, after a predetermined operation is selected, determining the content of the selection in the middle of or the vicinity of the plurality of operation buttons operable in at least vertical and horizontal directions, or
a single operation button operable in at least vertical and horizontal direction and fulfilling the same function as the enter button, when pressed at any one site.

12. The remote control device according to claim 1, wherein the operation unit is equipped with at least one button having the same functions as those of the right and left buttons of a mouse to arbitrarily execute an operation corresponding to the position of the cursor displayed on a display.

13. The remote control device according to claim 1, wherein the operation unit has a menu button having a function for displaying a list of contents and/or operation items provided by the controlled apparatus, and has a back button disposed in the vicinity of the menu button, for returning to the last menu display when selecting menu items sequentially.

14. The remote control device according to claim 1, wherein the main body has a volume button for adjusting the volume of the controlled apparatus and a power button for turning on/off the controlled apparatus.

15. The remote control device according to claim 1, characterized in that one or more transmission units are provided in the vicinity of the operation unit and/or in the vicinity of a portion on the opposite side of the operation unit and transmit as infrared signals the transmission code converted by the conversion unit and an operation instruction command provided by the operation unit to the controlled apparatus.

16. The remote control device according to claim 15, wherein at least one of the transmission units is provided at a distal end portion on the opposite side of the operation unit.

17. The remote control device according to claim 16, wherein the transmission units are provided with infrared light emitting devices disposed at predetermined intervals in the circumference direction about the longitudinal axis of the main body.

18. The remote control device according to claim 15, wherein
the transmission units each comprise one or more infrared light emitting devices for emitting direct light to the side of the main body and a convex mirror portion or a diffuse reflection plate provided on the side of the main body, and a transmission region is expanded by reflecting direct light emitted from the infrared light emitting devices by the convex mirror portion or the diffuse reflection plate in many directions.

19. The remote control device according to claim 1, having a function that can perform vertical and horizontal direction operations, wherein
in a state that a predetermined menu is displayed on a display and a plurality of items in the menu are selectable, one item can be selected and determined by recognizing a tilt of the longitudinal axis of the main body within a predetermined time period;
an item positioned above or below the one item is selected by using the main body like a joystick and, from an initial tilt state of the main body, tilting the main body once at a predetermined angle or more in the opposite direction of an operator or tilting the main body once at a predetermined angle or more in the direction toward the operator, and an item positioned on the left or right side of the one item is selected by using the main body like a joystick and, from an initial tilt state of the main body, tilting the main body once at a predetermined angle or more to the left relative to the operator or tilting the main body once at a predetermined angle or more to the right relative to the operator, and, the remote control device is put into a standby state for a next operation if the main body is returned to the initial tilt state within a predetermined time period; and
if the predetermined time period elapses, the items in vertical and horizontal directions are sequentially displayed and selected every time a predetermined time period elapses until the main body is returned to the initial tilt state.

20. The remote control device according to claim 1, having a function that can perform vertical and horizontal direction operations, wherein
in a state that a cursor is displayed on the display, and a predetermined item is selected and waiting to be determined or no item is selected, the main body is used like a joystick by touching an arbitrary medium surface with the optical reading unit and recognizing temporal change in tilt of the longitudinal axis of the main body by a predetermined method;
when the main body is tilted at a predetermined angle or more in an arbitrary direction from a tilting state of the main body to the medium surface, the cursor is moved according to a predetermined algorithm corresponding to an angle changed by tilting in the same direction, and an item becomes selected if the cursor is positioned over the item; and
if the main body is returned to an initial tilting state, the cursor is stopped and the remote control device is put into a standby state for a next operation.

21. The remote control device according to claim 1, having a function that can perform vertical and horizontal direction operations, wherein
the main body is in an initial tilting state when the main body is approximately perpendicular to the medium surface with the optical reading unit touching the medium surface at the start time of recognizing a tilt;
calibration setting is performed using the contrast state of an image read by the optical reading unit in the initial tilting state as an initial contrast state; and
a change in angle when the main body is tilted with the optical reading unit kept in touch with the medium surface is relatively recognized by a difference between the contrast state of an image captured by the optical reading unit and the initial contrast state.

22. A remote control device for operating a set-top box, a mobile phone, a game console or the like, as a controlled apparatus, connected to a television or a display device, comprising:
an optical reading unit equipped on a predetermined medium surface, for reading an optically readable dot pattern made into a pattern based on a predetermined algorithm;
a main body that is provided in connection with the optical reading unit and can be held like a pen or gripping-held according to a user and/or a purpose of use;
a conversion unit equipped within the main body, for analyzing a dot code and/or a coordinate value from the dot pattern read out by the optical reading unit and converting the dot code and/or the coordinate value into one or more corresponding transmission codes;
an operation unit equipped on a surface of the main body in the vicinity of the optical reading unit and operable with a fingertip, for at least moving a cursor, selecting a menu, selecting a program and determining the selections being displayed on the television or the display device; and
one or more transmission units equipped in the main body, for transmitting as signals the transmission code converted by the conversion unit and an operation instruction command provided by the operation unit to the controlled apparatus, the remote control device having
a function that can perform vertical and horizontal direction operations, wherein
in a state that a predetermined menu is displayed on a display and a plurality of items in the menu are selectable, one item can be selected and determined by recognizing a tilt of the longitudinal axis of the main body within a predetermined time period;
an item positioned above or below the one item is selected by using the main body like a joystick and, from an initial tilt state of the main body, tilting the main body once at a predetermined angle or more in the opposite direction of an operator or tilting the main body once at a predetermined angle or more in the direction toward the operator, and an item positioned on the left or right side of the one item is selected by using the main body like a joystick and, from an initial tilt state of the main body, tilting the main body once at a predetermined angle or more to the left relative to the operator or tilting the main body once at a predetermined angle or more to the right relative to the operator, and, the remote control device is put into a standby state for a next operation if the main body is returned to the initial tilt state within a predetermined time period; and
if the predetermined time period elapses, the items in vertical and horizontal directions are sequentially displayed and selected every time a predetermined time period elapses until the main body is returned to the initial tilt state.

23. A remote control device for operating a set-top box, a mobile phone, a game console or the like, as a controlled apparatus, connected to a television or a display device, comprising:
an optical reading unit equipped on a predetermined medium surface, for reading an optically readable dot pattern made into a pattern based on a predetermined algorithm;
a main body that is provided in connection with the optical reading unit and can be held like a pen or gripping-held according to a user and/or a purpose of use;
a conversion unit equipped within the main body, for analyzing a dot code and/or a coordinate value from the dot pattern read out by the optical reading unit and converting the dot code and/or the coordinate value into one or more corresponding transmission codes;
an operation unit equipped on a surface of the main body in the vicinity of the optical reading unit and operable with a fingertip, for at least moving a cursor, selecting a menu, selecting a program and determining the selections being displayed on the television or the display device; and
one or more transmission units equipped in the main body, for transmitting as signals the transmission code converted by the conversion unit and an operation instruction command provided by the operation unit to the controlled apparatus, the remote control device having
a function that can perform vertical and horizontal direction operations, wherein
in a state that a cursor is displayed on the display, and a predetermined item is selected and waiting to be determined or no item is selected, the main body is used like a joystick by touching an arbitrary medium surface with the optical reading unit and recognizing temporal change in tilt of the longitudinal axis of the main body by a predetermined method;
when the main body is tilted at a predetermined angle or more in an arbitrary direction from a tilting state of the main body to the medium surface, the cursor is moved according to a predetermined algorithm corresponding to an angle changed by tilting in the same direction, and an item becomes selected if the cursor is positioned over the item; and
if the main body is returned to an initial tilting state, the cursor is stopped and the remote control device is put into a standby state for a next operation.

24. A remote control device for operating a set-top box, a mobile phone, a game console or the like, as a controlled apparatus, connected to a television or a display device, comprising:
an optical reading unit equipped on a predetermined medium surface, for reading an optically readable dot pattern made into a pattern based on a predetermined algorithm;
a main body that is provided in connection with the optical reading unit and can be held like a pen or gripping-held according to a user and/or a purpose of use;
a conversion unit equipped within the main body, for analyzing a dot code and/or a coordinate value from the dot pattern read out by the optical reading unit and converting the dot code and/or the coordinate value into one or more corresponding transmission codes;
an operation unit equipped on a surface of the main body in the vicinity of the optical reading unit and operable with a fingertip, for at least moving a cursor, selecting a menu, selecting a program and determining the selections being displayed on the television or the display device; and
one or more transmission units equipped in the main body, for transmitting as signals the transmission code converted by the conversion unit and an operation instruction command provided by the operation unit to the controlled apparatus, the remote control device having
a function that can perform vertical and horizontal direction operations, wherein
the main body is in an initial tilting state when the main body is approximately perpendicular to the medium surface with the optical reading unit touching the medium surface at the start time of recognizing a tilt;
calibration setting is performed using the contrast state of an image read by the optical reading unit in the initial tilting state as an initial contrast state; and
a change in angle when the main body is tilted with the optical reading unit kept in touch with the medium surface is relatively recognized by a difference between the contrast state of an image captured by the optical reading unit and the initial contrast state.
